(19) United States
(12) Patent Application Publication
(10) Pub. No.: US 2022/0253864 A1
(43) Pub. Date: Aug. 11, 2022

(54) TRIGGERING COMPUTER SYSTEM PROCESSES THROUGH MESSAGING SYSTEMS

(71) Applicant: Klarna Bank AB, Stockholm (SE)

(72) Inventor: Sebastian Marcin Siemiatkowski, Stockholm (SE)

(21) Appl. No.: 17/173,132

(22) Filed: Feb. 10, 2021

(51) Int. Cl. G06Q 20/42; G06Q 20/38

(52) U.S. Cl. CPC G06Q 20/42; G06Q 20/386

(57) ABSTRACT

A filter rule that corresponds to an entity is obtained. An occurrence of a match to the filter rule is determined to be in a first message on a platform of an interactive multiuser computer service. An application on a device of a user associated with the first message is caused to prompt the user to authorize a transfer according to a value included in the first message. An indication from the user is received via the device of the user. If the indication is authorization to complete the transfer the transfer between a set of user records of the user at a provider and the entity is completed, where the provider is a separate entity from the entity. Finally, a second message indicating completion of the transfer is transmitted to the interactive multiuser computer service.

### CROSS REFERENCE TO RELATED APPLICATIONS

This application incorporates by reference for all purposes the full disclosure of co-pending U.S. patent application Ser. No. 16/744,017, filed Jan. 15, 2020, entitled “INTERFACE CLASSIFICATION SYSTEM” (Attorney Docket No. 0101560-015US0); U.S. patent application Ser. No. 16/744,021, filed Jan. 15, 2020, entitled “METHOD OF TRAINING A LEARNING SYSTEM TO CLASSIFY INTERFACES” (Attorney Docket No. 0101560-019US0); U.S. Pat. No. 10,846,106, filed Mar. 9, 2020, entitled “REAL-TIME INTERFACE CLASSIFICATION IN AN APPLICATION” (Attorney Docket No. 0101560-016US0); U.S. patent application Ser. No. 17/101,744, filed Nov. 23, 2020, entitled “REAL-TIME INTERFACE CLASSIFICATION IN AN APPLICATION” (Attorney Docket No. 0101560-016US1); U.S. patent application Ser. No. 16/680,392, filed Nov. 11, 2019, entitled “DYNAMIC LOCATION AND EXTRACTION OF A USER INTERFACE ELEMENT STATE IN A USER INTERFACE THAT IS DEPENDENT ON AN EVENT OCCURRENCE IN A DIFFERENT USER INTERFACE” (Attorney Docket No. 0101560-008US0); U.S. patent application Ser. No. 16/680,396, filed Nov. 11, 2019, entitled “UNSUPERVISED LOCATION AND EXTRACTION OF OPTION ELEMENTS IN A USER INTERFACE” (Attorney Docket No. 0101560-009US0); U.S. patent application Ser. No. 16/680,403, filed Nov. 11, 2019, entitled “DYNAMIC IDENTIFICATION OF USER INTERFACE ELEMENTS THROUGH UNSUPERVISED EXPLORATION” (Attorney Docket No. 0101560-010US0); U.S. patent application Ser. No. 16/680,406, filed Nov. 11, 2019, entitled “LOCATION AND EXTRACTION OF ITEM ELEMENTS IN A USER INTERFACE” (Attorney Docket No. 0101560-011US0); U.S. patent application Ser. No. 16/680,408, filed Nov. 11, 2019, entitled “UNSUPERVISED LOCATION AND EXTRACTION OF QUANTITY AND UNIT VALUE ELEMENTS IN A USER INTERFACE” (Attorney Docket No. 0101560-012US0); and U.S. patent application Ser. No. 16/680,410, filed Nov. 11, 2019, entitled “EXTRACTION AND RESTORATION OF OPTION SELECTIONS IN A USER INTERFACE” (Attorney Docket No. 0101560-013US0).

### BACKGROUND

Enabling users of an interactive multiuser computer service to perform operations requiring authentication with a third-party service or application is often cumbersome or impractical unless that third-party service or application has been integrated in some manner with the interactive multiuser computer service platform itself. Without such integration, performing some actions involving the third-party service or application typically cannot be initiated from the interactive multiuser computer service platform and requires that the user perform the actions directly with the third-party service or application rather than through the interactive multiuser computer service. Additionally, it is difficult for other users of the interactive multiuser computer service to verify, on the interactive multiuser computer service platform, the validity of a claim by a user purporting to have performed some action that would have required authentication to the third-party service or application.

### BRIEF DESCRIPTION OF THE DRAWINGS

Various techniques will be described with reference to the drawings, in which:

FIG. 1 illustrates an example of a provider-enabled transfer from a user and another entity via an interactive multiuser computer service in accordance with an embodiment;

FIG. 2 illustrates an example of a message posted to an interactive multiuser computer service in accordance with an embodiment;

FIG. 3 illustrates an example of monitoring in accordance with a filtering rule in accordance with an embodiment;

FIG. 4 illustrates an example of prompting a user to confirm a transfer in accordance with an embodiment;

FIG. 5 illustrates an example of a confirmation interface in accordance with an embodiment;

FIG. 6 illustrates an example of confirmation of a transfer in accordance with an embodiment;

FIG. 7 is a swim diagram that illustrates an example of performing a third-party-enabled transfer via an interactive multiuser computer service platform in accordance with an embodiment;

FIG. 8 is a flowchart that illustrates an example of a third-party provider service determining how to interact with control functions of an interface using machine learning accordance with an embodiment;

FIG. 9 is a flowchart that illustrates an example of a client device of a user performing a transfer process in accordance with an embodiment;

FIG. 10 is a flowchart that illustrates an example of a third-party provider service application performing a transfer process on a client device of a user in accordance with an embodiment;

FIG. 11 is a flowchart that illustrates an example of a third-party provider service performing a transfer process in accordance with an embodiment;

FIG. 12 is a flowchart that illustrates a third-party provider service classifying an interface in accordance with an embodiment;

FIG. 13 is a flowchart that illustrates an example of monitoring an interactive multiuser computer service for a filter rule in accordance with an embodiment;

FIG. 14 is a flowchart that illustrates an example of an entity configuring a system to enable a transfer in accordance with an embodiment; and

FIG. 15 illustrates a computing device that may be used in accordance with at least one embodiment/an environment in which various embodiments can be implemented.

### DETAILED DESCRIPTION

Various interactive multiuser computer services include features where users of their platform can mark information they share with a metadata tag that enables cross-referencing of content. A metadata tag can often be searchable and trackable by monitoring services, and many entities utilize these metadata tags to further viral movements on the interactive multiuser computer service platforms. Techniques and systems described below relate to a system that, using metadata tags, can authenticate a user of an interactive multiuser computer service outside of the interactive multiuser computer service platform and perform an operation requiring authentication initiated from the interactive multiuser computer service.

In one example, a filter rule that corresponds to a first set of user records at a service provider is provided to a monitoring service. In the example, a first notification is received from the monitoring service indicating that a match to the filter rule has been detected in a first message on a platform of an interactive multiuser computer service, where the match includes a value, and where the first message was generated by a user of the platform.

Further in the example, as a result of determining that the user is associated with a second set of user records at the service provider, an application on the client device is caused, by transmitting a second notification to a client device of the user, to generate an interface with a prompt to authorize a transfer according to the value. Still in the example the transfer is completed in response to receiving, from the client device, an authorization of the transfer. Finally, in the example, a third message indicating successful completion of the transfer is transmitted to the interactive multiuser computer service.

In the preceding and following description, various techniques are described. For purposes of explanation, specific configurations and details are set forth in order to provide a thorough understanding of possible ways of implementing the techniques. However, it will also be apparent that the techniques described below may be implemented in different configurations without the specific details. Furthermore, well-known features may be omitted or simplified to avoid obscuring the techniques being described.

Techniques described and suggested in the present disclosure improve the field of computing, especially the field of user authentication, by detecting from a message on an interactive multiuser computer service platform that a user seeks to perform an action that requires authentication, and authenticating the user without further operations performed by the interactive multiuser computer service. Additionally, techniques described and suggested in the present disclosure improve the efficiency of interactive multiuser computer services because it allows third-party services to interact with and authenticate users of the interactive multiuser computer service without requiring special hardware or software integration with the interactive multiuser computer service platform. Moreover, techniques described and suggested in the present disclosure are necessarily rooted in computer technology in order to overcome problems specifically arising with the lack of ability to authenticate users of an interactive multiuser computer service without involving the interactive multiuser computer service in the authentication.

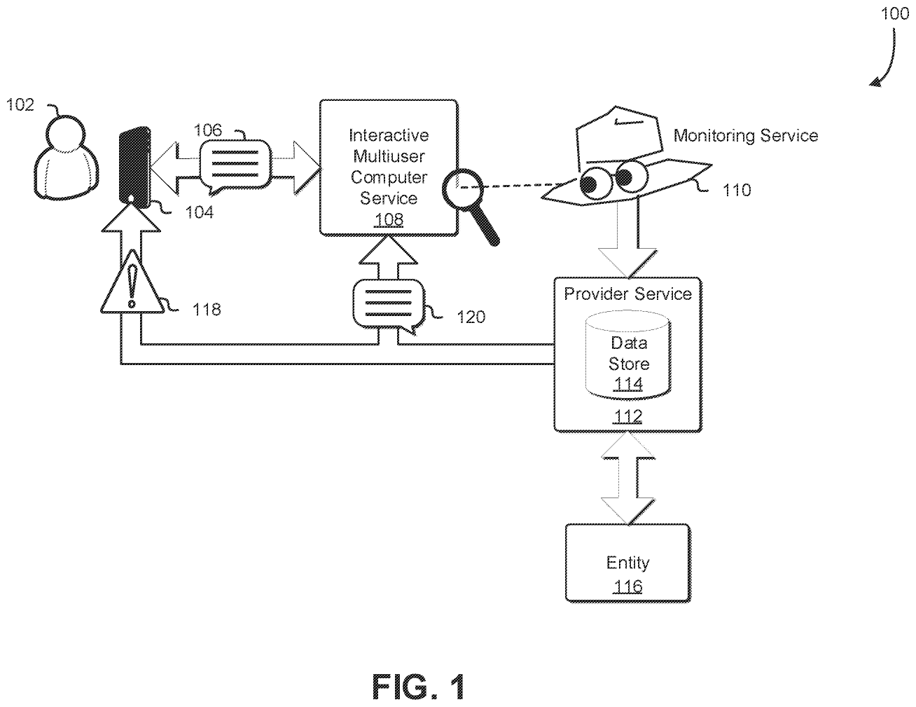

FIG. 1 illustrates an environment 100 in which an embodiment of the present disclosure may be implemented. As depicted in FIG. 1, the environment 100 may include a user 102 interacting with a client device 104 to upload a first message 106 to an interactive multiuser computer service 108 platform being monitored by a monitoring service 110. In the environment 100 the monitoring service 110 may detect that the message fulfills criteria corresponding to a filter rule, and as a result of the detecting, may notify a provider service 112 about the match to the filter rule. The result of matching the filter rule may be to cause the provider service 112 to initiate a process involving launching an application on the client device 104, authenticating the user, and, in various embodiments, performing a transfer between the user 102 and an entity 116. Thus, the provider service 112 may access a data store to determine an identity of the user 102 and/or an identity of an entity 116 associated with the filter rule. The provider service 112 may send a notification 118 to a provider-provided application running on the client device 104 to initiate the process and prompt the user 102 as to whether the user 102 intends to proceed with performance of the process. Upon receiving confirmation from the user 102 via the user device, the provider service 112 may authenticate the user 102, may perform a transfer between the user 102 and the entity 116, and, upon completion of the process, reply to the first message 106 on the interactive multiuser computer service 108 platform with a second message 120 indicating completion of the process.

The user 102 may represent an individual, a computing system, an executing software application, a computing service, a computing resource, or other entity capable of controlling input to and receiving (e.g., visually, auditorily, etc.) output from the client device 104. The user 102 may have access to a set of user records and/or a profile with the interactive multiuser computer service 108, and may have a set of credentials (e.g., username, password, etc.) registered with the interactive multiuser computer service 108. In the present disclosure, a “set of user records” refers to a stored set of information at the respective service (e.g., the provider service 112, the monitoring service 110, the interactive multiuser computer service 108, etc.) that allows a user, an entity, or another service to authenticate to the respective service and to receive authorization to access resources provided by or connected to the respective service. To connect (log on) to the respective service, the connecting user, entity, or other service may authenticate itself with a username and password or other credentials. For example, the user 102 may authenticate to the interactive multiuser computer service 108 by presenting proof of possession of security credentials, such as by inputting one or more of a username, a password, access key, and/or digital signature via the client device 104, to gain access to the set of user records with the interactive multiuser computer service 108. The set of user records may include additional information associated with the respective user, entity, or other service, such as an identity of an account with the interactive multiuser computer service 108, one or more filter rules for the user, entity, or other service, an amount of a particular unit type that can be transferred out of the set of user records to another set of user records, and so on. The provider service 112 may store the set of user records for its users in the data store 114.

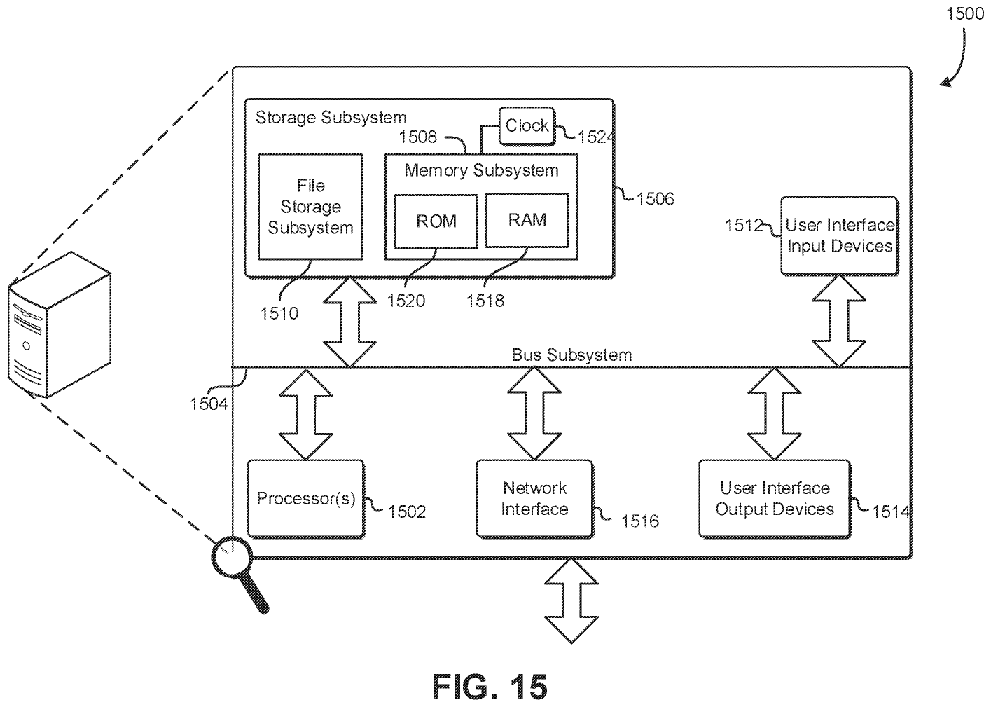

The client device 104, in some embodiments, is embodied as a physical device and may be able to send and/or receive requests, messages, or information over an appropriate network. Examples of such devices include personal computers, cellular telephones, handheld messaging devices, laptop computers, tablet computing devices, set-top boxes, personal data assistants, embedded computer systems, electronic book readers, and the like, such as the computing device 1500 described in conjunction with FIG. 15. Components used for such a device can depend at least in part upon the type of network and/or environment in which the embodiment is implemented. Protocols and components for communicating via such a network are well known and will not be discussed in detail. Communication over such a network may be enabled by wired or wireless connections and combinations thereof.

The interactive multiuser computer service 108 may be a computing resource service that allows users to share messages, digital images, and/or videos with other users of the interactive multiuser computer service 108. The interactive multiuser computer service 108 may be a social networking service that enables users to build social networks or social relationships with other users who share similar interests, activities, backgrounds, or connections with other users. Additionally or alternatively, the interactive multiuser computer service 108 may be a blogging or microblogging service that allows users to transfer content, such as text, images, or video. Additionally or alternatively, the interactive multiuser computer service 108 may be a messaging service that allows users to send text messages, voice messages, share images, documents, user locations, live video, or other content with other users. Examples of interactive multiuser computer services include Twitter, Facebook, Parler, MySpace, Google+, Tumblr, YouTube, Instagram, Tik Tok, Snapchat, Reddit, Pinterest, Quora, Skype, and WhatsApp.

The interactive multiuser computer service 108 may provide each user with an individual forum on the interactive multiuser computer service 108 platform for the user to share content (e.g., the first message 106) and for other users to view, listen to, interact with, respond to, and comment upon the shared content (e.g., the second message 120). In some examples, a “platform” refers to software and/or hardware through which a computer service, such as the interactive multiuser computer service 108, implements its services for its users. The interactive multiuser computer service 108 platform may include functionality that allows the use of metadata tags. In some examples, a “metadata tag” refers to a keyword or term assigned to a piece of information. A metadata tag may help to describe an item to a classification, indicate possession, note boundaries, or indicate online identity and allowed to be found by browsing or searching. A metadata tag may be chosen informally by an item's creator or by its viewer. An example of a metadata tag is a hashtag. In some examples, a “hashtag” refers to a metadata tag that is prefaced by a hash symbol (#). Note however, that it is contemplated that a metadata tag may be prefaced or appended by various symbols or character combinations other than hash symbol, or may not even be prefaced or appended by a symbol at all.

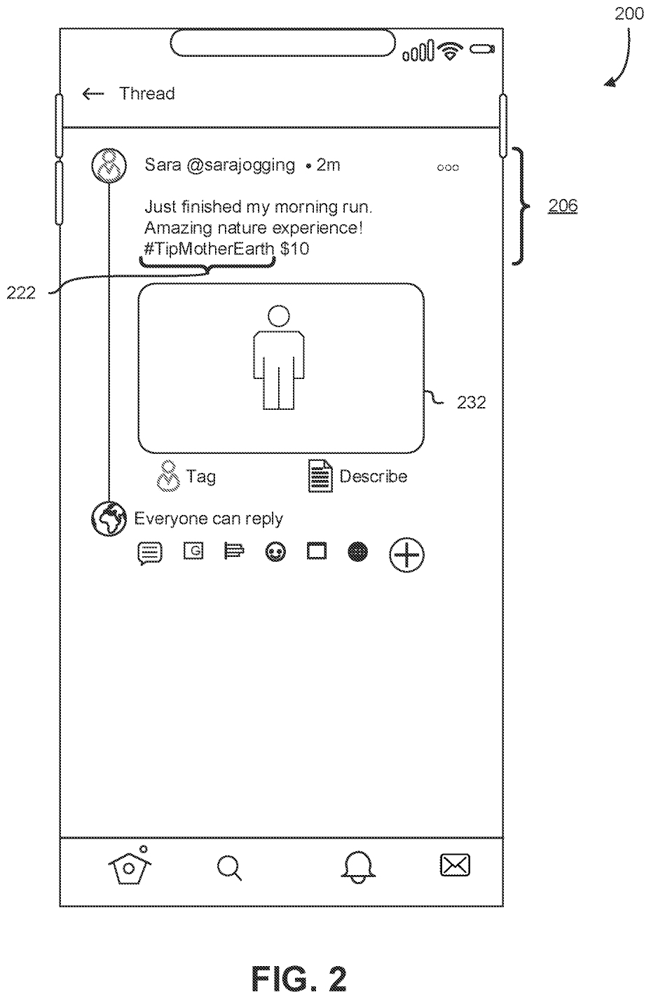

The first message 106 may be data, such as text, graphics, audio, video, animation, or a hyperlink, directed by the client device 104 under the control of the user 102 to be uploaded to the interactive multiuser computer service 108. As noted above, the user 102 may have a set of user records with the interactive multiuser computer service 108 that includes a forum associated with the user 102 whereby the first message 106 may be posted to the forum and shared with other users of the interactive multiuser computer service 108. The first message 106 may also include one or more metadata tags as described in the present disclosure. An illustrative example of the first message 106 can be seen in FIG. 2.

The monitoring service 110 may be a third-party service for monitoring interactive multiuser computer service platforms. The monitoring service 110 may deliver alerts to its clients when it detects a match to a filter rule in a forum on a monitored interactive multiuser computer service platform. In various embodiments, the provider service 112 may be a client of the monitoring service 110. In some examples, “detect” refers to sense, perceive, identify, discover, ascertain, respond to, and/or receive the existence, presence, and/or fact of. In various embodiments, a “match” does not necessarily require equality. For example, two values may match if they are not equal but are equivalent. As another example, two values may match if they correspond to a common object (e.g., value) or are in some predetermined way complementary and/or they satisfy one or more matching criteria. Generally, any way of determining whether there is a match may be used. For example, a regular expression filter rule of “ab+c” may match “abc,” “abbc,” “abbbc,” and so on (but not “ac”).

The provider service 112 may be another third-party service to which the user 102 may be subscribed. The provider service 112 may have the ability to enable a transfer of items, services, or value between the user 102 and the entity 116. In some embodiments, the provider service 112 may be capable of authenticating the user 102 as described in the present disclosure. The provider service 112 may provide a software application to the user 102 for execution on the client device 104, and the software application, when executed, may aid in enabling the transfer and/or authentication. In some implementations, the provider service 112 may be a services provider that provides network accessible systems to enable value transfers between users and other entities.

The data store 114 may be may be a repository providing non-transitory, persistent (non-volatile) storage for data objects, such as database records, flat files, and other data objects. Examples of data stores include file systems, relational databases, non-relational databases, object-oriented databases, comma delimited files, and other files. In some implementations, the data store 114 is a distributed data store. The data store 114 may store set of user records information for the user 102 and information identifying the user 102's set of user records with the interactive multiuser computer service 108. In this manner, the provider service 112 can determine which of its users is associated with the first message 106 on the interactive multiuser computer service 108 platform. Additionally or alternatively, the data store 114 may store set of user records information for the entity 116 and one or more filter rules associated with the entity 116. In this manner, the provider service 112 can determine which entity is to be the recipient of the transfer depending on the filter rule matched by the monitoring service.

For example, the user 102 may register his/her interactive multiuser computer service set of user records with the provider service 112. The provider service 112 may perform an initial verification process (e.g., using an application programming interface of the interactive multiuser computer service 108) to confirm that the interactive multiuser computer service 108 set of user records corresponds to the user 102. Thereafter, if the monitoring service 110 notifies the provider service 112 that a user set of user records of the interactive multiuser computer service 108 is associated with a posting of a metadata tag that corresponds with a filter rule provided by the provider service 112, the provider service 112 can access the data store 114 to determine that the interactive multiuser computer service 108 user set of user records corresponds to the user 102. Accordingly, the provider service 112 can push the notification 118 to the client device 104 of the user 102 to prompt the user 102 to initiate a process associated with the filter rule. In some examples, an application programming interface refers to a set of subroutine definitions, communication protocols, and/or software tools that provide a method of communication with components of a computing service, such as the monitoring service 110, a service of the provider service 112, or the interactive multiuser computer service 108.

The data store 114 may also store the relationship between the filter rule and the entity 116. As an illustrative example, the entity 116 may be a nature preserve named “MotherEarth” and may register a filter rule involving a hashtag “#TipMotherEarth” with the provider service 112. Thereafter, if the monitoring service 110 detects and reports to the provider service 112 that the first message 106 includes the “#TipMotherEarth” hashtag, the provider service 112 may access the data store 114 to identify that the hashtag corresponds to the “MotherEarth” entity and perform a process involving the user 102 and the entity 116, such as a transfer of value from the user 102 to the entity 116.

The entity 116 may be an individual, a group of individuals, an enterprise, or other group of individuals that has registered a filter rule, with the provider service 112, of the type described in the present disclosure. In some embodiments, the entity 116 is another user of the interactive multiuser computer service 108 also having a set of user records at the provider service 112.

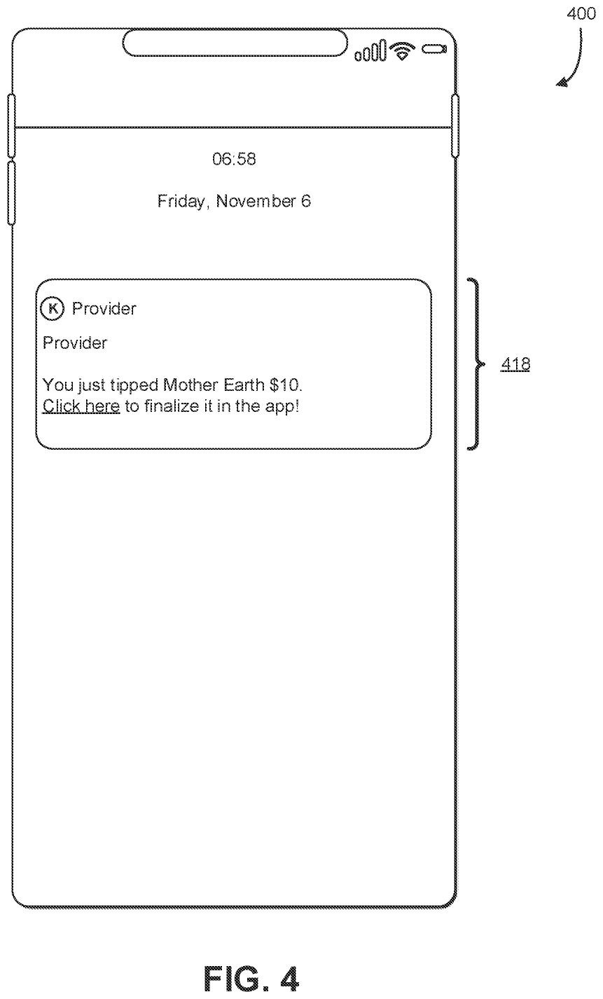

The notification 118 may be an alert, a signal, or a message sent to the client device 104 by the provider service 112. In embodiments, the notification 118 is sent to the client device 104 through a network, such as the Internet, which may trigger the client device 104 to display an alert. The client device 104 may have downloaded and installed software application from the provider service 112, and selecting the alert or launching the downloaded software application may cause the notification 118 to be displayed to the user 102 on the client device 104. However, it is also contemplated that, in some embodiments, the notification 118 may be provided to the client device 104 via the interactive multiuser computer service 108; for example, the interactive multiuser computer service 108 platform may include a direct messaging feature through which the provider service 112 can additionally or alternatively direct the notification 118 to the user 102. In such an embodiment, selecting a hyperlink or other interface object (e.g., a graphical button) in the direct message via downloaded software for the interactive multiuser computer service 108 on the client device 104 may launch the downloaded software application from the provider service 112 on the client device 104. An illustrative example of such direct message can be seen in FIG. 4. Further, in some embodiments the software application from the provider service 112 may not yet be downloaded on the client device 104. In such embodiments, selecting the hyperlink or other interface object from the direct message may cause the client device 104 to prompt the user 102 to download the provider service 112's software application.

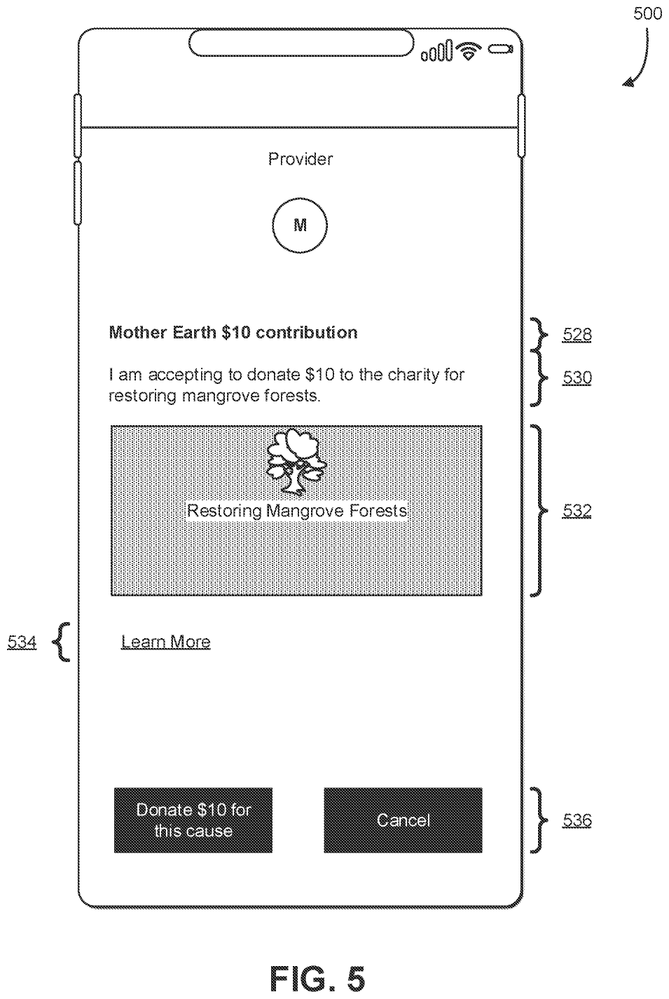

Launching the downloaded software application of the provider service 112 on the client device 104 may cause the client device 104 to continue with the process initiated by the metadata tag that the user 102 included in the first message 106. As one example, as can be seen in FIG. 5, the downloaded software application is prompting the user 102 to confirm or deny a transfer with the entity 116 triggered by the hashtag that the user 102 included in the message 206 of FIG. 2. The user 102 input to the downloaded software application (e.g., confirm, deny, etc.) may be provided to the provider service 112, which may cause the provider service 112 to further perform the process (e.g., process the transfer with the entity 116), and respond with the second message 120 via the interactive multiuser computer service 108.

The second message 120 may be a response to the first message 106. For example, if the user 102 agreed to proceed with the transfer depicted in FIG. 5, the response may be a comment from the provider service 112 or from the entity 116 thanking the user 102 for completing the transfer. On the other hand, had the user 102 denied or otherwise failed to complete the transfer, the second message 120 may be a message indicating that the transfer was not yet completed. Thus, the second message 120, as a reply to the first message 106, may indicate one or more statuses of the process initiated by the monitoring service 110 detecting a match to a filter rule in the first message 106. The second message 120 may serve multiple beneficial purposes, such as providing proof to other users of the interactive multiuser computer service 108 that the process initiated by the user 102 was successfully (or unsuccessfully) performed, informing the other users that they, too, may initiate a similar process, and/or allows a third-party-enabled process to be triggered and performed without requiring integration with the interactive multiuser computer service 108 platform.

FIG. 2 illustrates an interface 200 on a client device in accordance with an embodiment of the present disclosure. Specifically, FIG. 2 depicts a message 206 with a hashtag 222 displayed in the interface 200 of the client device. The interface 200 may be a user interface that allows the user to interact with the client device of FIG. 1. The interface 200 may include graphical elements such as text, graphical icons, audio, animations, and/or video to relay information to the user. Some of such graphical elements may be engaged with through the client device, such as by using a touch screen on the client device, by using voice commands audible to a microphone of the client device, and/or by using an input device (e.g., keyboard, mouse, etc.) communicatively coupled to the client device. The interface may be implemented on the client device in hardware and/or software. A web page is one example of an interface contemplated by the present disclosure. A graphical user interface of a computing application is another example of an interface contemplated by the present disclosure.

The message 206 may be a message similar to the first message 106 of FIG. 1. In the illustrative example depicted in FIG. 2, a user named “Sara” with the username of “@sarajogging” on an interactive multiuser computer service has just finished a morning jog through nature and, as a result of wanting to share her experience with other users of the interactive multiuser computer service, posts an image 232 and the message 206 “Just finished my morning run. Amazing nature experience!” In addition, Sara has posted a hashtag “#TipMotherEarth $10” that Sara may be aware will trigger a third-party provider process to enable a transfer of $10 from Sarah to an entity named “MotherEarth,” which may be the name of an entity dedicated to preserving natural resources.

The hashtag 222 may be a metadata tag that matches a filter rule associated with the entity of FIG. 1. In the illustrative example depicted in FIG. 2, an entity named “MotherEarth” has registered the hashtag 222 with the provider service and this registration may be stored in the data store. The provider service may have submitted, through an application programming interface of the tracking service, a filter rule stating to monitor for any occurrence of the hashtag 222 “#TipMotherEarth” followed by a unit type and a numeric value.

The image 232 may be a digital image uploaded to the interactive multiuser computer service platform by the user. The image 232 may be two-dimensional image of a scene captured by an image capture device. The image 232 may be a numeric (e.g., binary) representation of a two-dimensional image that comprises a set of picture elements (pixels). The image 232 may contain a fixed number of rows and columns of pixels holding values that represent the brightness of a given color at that specific point. The image 232 may be formatted according to a specific image format, such as Graphics Interchange Format (GIF), JPEG, Portable Network Graphics (PNG), bitmap (BMP), or Tagged Image File Format (TIFF). In the illustrative example of FIG. 2, the image 232 may be a digital photograph of an area of nature that Sara captured on her client device during her jog.

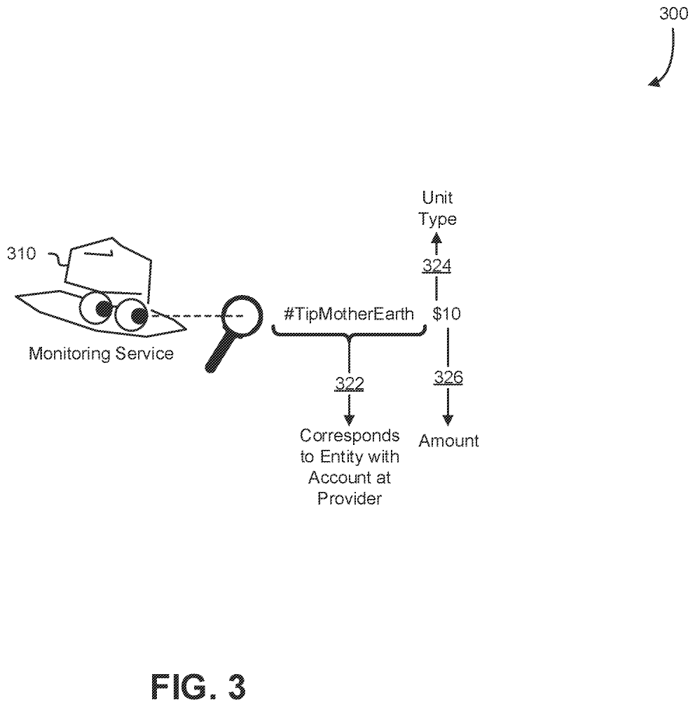

FIG. 3 illustrates an aspect of a system 300 of an embodiment of the present disclosure. FIG. 3 depicts a representation of a monitoring service 310 as it detects a match to a filter rule, the match including a metadata tag 322 followed by a unit type 324 and a numeric value 326. In some examples, a filter rule of the present disclosure may be a set of rules or a search pattern used by the monitoring service 310 to match a particular character string. One example of a filter rule may be a regular expression that matches the particular character string. A regular expression filter rule for the entity MotherEarth matching the metadata tag 322, the unit type 324, and the numeric value 326 depicted in FIG. 3 may be “m/(\hat{ }|\B)#TipMotherEarth\s\$[0-9] (\b|\r)/”; that is, a character string beginning with “#,” followed by the character string “TipMotherEarth,” a whitespace character, the “$” character, and ending with one or more numerals. It is contemplated, however, that other representations of a filter rule are possible besides regular expressions.

The monitoring service 310 may be, similar to the monitoring service 110 of FIG. 1, a third-party service that monitors messages shared on the interactive multiuser computer service. The monitoring service 310 may have access to the interactive multiuser computer service platform through an application programming interface provided by the interactive multiuser computer service for use. Such application programming interfaces may allow the monitoring service 310 to search for particular metadata tags (such as the metadata tag 322) and identify a user set of user records associated with the use of a particular metadata tag (e.g., posted in a message on a forum of the user set of user records). When the monitoring service 310 detects a match to a filter rule in a message on a forum of the user set of user records, the monitoring service 310 may send a notification to the provider service that includes a message identifier (so the provider service can determine which message to reply to), an identifier for the user, the identity of the filter rule matched, and other metadata usable by the provider service (such as an amount and unit type, entity identifier, item/service identifier, etc., as required).

The metadata tag 322 may be a keyword or term associated with an entity, such as the entity 116 of FIG. 1. The metadata tag 322 may be part of a filter rule, as described above, that the monitoring service 310 monitors the usage of in individual forums with the interactive multiuser computer service. In some embodiments, the metadata tag 322 may begin or end with a symbol, such as the “#” preceding “TipMotherEarth” in FIG. 3, indicating that it is a hashtag.

The filter rule being monitored by the monitoring service 310 may further include a numeric value 326 and/or a unit type 324. The numeric value 326 may be a number indicating an amount of the unit type 324. Although the regular expression filter rule given as an example above is specific to whole numbers, it is contemplated that filter rules using fractional or exponential numbers could be utilized in some implementations.

The unit type 324 may be any type of unit that can be quantized. In the illustrative example in FIG. 3, the unit type 324 is a “$”; however, it is contemplated that the unit type 324 could be a symbol for some other medium of transfer, could be spelled out (e.g., “USD,” “EUR,” “CZK,” etc.), or could be some other unit type. For example, the filter rule could be looking for pledges of time to commit to performing a community service and the unit type 324 could be “days,” “minutes,” or some other unit of time. As another example, the filter rule could be a pledge to run or walk a certain distance for a local foundation, and the unit type 324 could accordingly be in miles or kilometers, and so on.

It is contemplated that the order of the metadata tag 322, the unit type 324, and the numeric value 326 could vary depending on implementation. For example, the unit type 324 and the numeric value 326 could be reversed or could precede the metadata tag 322. It is further contemplated that, in some embodiments, the unit type 324 and the numeric value 326 need not be included. For example, if the user prefers to keep the amount of the contribution to MotherEarth private, the user could just input “#TipMotherEarth” without an amount. In the interface of a software application of the provider service 112 running on the client device 104, such as the interface 500 of FIG. 5, the user could then specify the amount for the transfer in the interface without the amount being revealed on the interactive multiuser computer service platform. In such a case, the filter rule may just look for “#TipMotherEarth,” and the lack of a subsequent value may indicate to the provider service 112 to cause (by including information in or omitting information from the notification 118 that indicates the lack of the value) the software application to prompt the user for an amount.

It is still further contemplated that the transfer described in the present disclosure need not be a one-way transfer, but may involve a multi-directional transfer. For example, the entity 116 of FIG. 1 may have a set of user records with the interactive multiuser computer service 108 where the entity 116 has uploaded a digital image of an item, such as a t-shirt. The entity may register a metadata tag of “#BuyThisT-ShirtFor10Dollars” with the provider service 112. Thereafter, if the user 102 includes the metadata tag in the first message 106, the completion of the transfer may result in the entity 116 sending the t-shirt to an address associated with the user 102. In such a case, the second message 120 may include information such as a tracking number and estimated arrival for the t-shirt. Similarly, the user 102 may prefer to send an item of the entity as a present to another individual; in such an example, the user 102 may include in the first message 106, “#BuyThisT-ShirtFor10Dollars ShipTo: John Doe, 123 Main Street, Denver, Colo. 12345,” where the metadata tag is followed by information (e.g., a delivery address) usable to aid enablement of the transfer.

It is further contemplated that the transfer may be between two users of the interactive multiuser computer service. For example, the user 102 of FIG. 1 may be a first user of the interactive multiuser computer service 108 and the entity 116 may be a second user of the interactive multiuser computer service 108. In such an example, the first user may use a metadata tag corresponding to the provider service to make the transfer, such as “#SendFromProvider $10 To: John Doe Message: Love, Grandma.” Here, the first user (the entity 116) need not register the metadata tag, because the metadata tag originates from the provider service 112 itself; so long as both “John Doe” and “Grandma” both have set of user records with the interactive multiuser computer service 108 and the provider service 112, the metadata tag “#SendFromProvider” may be used to initiate the transfer. Note that in this example, the filter rule may be configured to capture additional information, such as the recipient (“John Doe”) of the transfer and a message (“Love, Grandma”) as a result of detecting matches to the keywords “To:” and “Message:” and capturing the text following the keywords.

FIG. 4 illustrates an interface 400 on a client device in accordance with an embodiment of the present disclosure. Specifically, FIG. 4 depicts an interface of a client device, such as the client device 104 of FIG. 1, prompting a user to complete a transfer initiated by the user as a result of the hashtag 222 of FIG. 2 being uploaded to the interactive multiuser computer service platform. The client device may include an installation of a software application provided by the provider service 112 of FIG. 1 to the client device 104 to enable the transfer. The client device, by virtue of having the software application downloaded and installed, may receive push notifications from the provider service, such as the notification 418, which may be displayed in the interface 400 to alert the user.

The notification 418 may be an indication to the user that the user's use of a metadata tag (e.g., the hashtag 222 of FIG. 2) that fulfills a filter rule has been detected. The notification 418 may include a prompt for the user to launch the software application of the provider service on the client device to complete the transfer initiated by the user's use of the metadata tag. Thus, the user's interaction with the interface 400 may cause the client device to continue with the process to complete the transfer.

FIG. 5 illustrates an interface 500 on a client device in accordance with an embodiment of the present disclosure. Specifically, FIG. 5 depicts an illustrative example of the interface 500 of a software application of a provider service, such as the provider service 112 of FIG. 1. The software application, through the interface 500, may allow the user to perform the next step in the process initiated by the user's use of a metadata tag (e.g., the hashtag 222 of FIG. 2) that fulfilled a filter rule monitored by the monitoring service (e.g., the monitoring service 110).

As noted above, the interface 500 may be an interface of a software application provided by the provider service for enabling a process initiated by the user's use of the metadata tag on the interactive multiuser computer service platform. The interface 500 may include various interface elements to relay information to the user and to allow the user to interact with the software application executing on the client device. The software application to which the interface 500 corresponds may be provided to the user for execution on the client device by the provider service. When the software application launches, it may require the user to authenticate with the provider service, such as by prompting the user to provide proof of possession of credentials (e.g., username and password), provide biometric data (e.g., facial recognition, thumbprint, etc.), perform multi-factor authentication, or some other manner of confirming the user's identity. Once the application has authenticated the user, the provider service can confirm access its data store (e.g., the data store 114 of FIG. 1) to determine what user set of user records with the interactive multiuser computer service the user identified as belonging to him/her; if the interactive multiuser computer service user set of user records matches the set of user records from which the message containing the metadata tag that triggered the transfer process, then the provider service has successfully authenticated the user. In this manner, a third-party provider service can authenticate a user without such authentication being incorporated into the interactive multiuser computer service platform.

The heading 528 may be a short description of the subject presented by the interface 500. In the illustrative example depicted in FIG. 5, the heading 528 describes the subject as being the “MotherEarth $10 contribution” initiated by the user in the message 206 of FIG. 2. The description 530 provides further information to the user on the nature of the portion of the process being performed. In the illustrative example of FIG. 5, the interface 500 informs the user that selecting the accept control object is accepting to transfer $10 to MotherEarth for the restoration of mangrove forests.

The entity identity 532 may be a logo or other identifying mark identifying the recipient of the transfer. The entity identity 532 may provide additional assurance to the user that the transfer is being directed to the correct entity (e.g., the entity 116 if FIG. 1). The additional information hyperlink 534 may be a hyperlink that opens up a window in the interface 500 or redirects the client device to another interface with additional information. For example, if “Learn more” is activated (e.g., by clicking, tapping, selecting, etc.), the client device may display more information about the entity, the cause supported by the entity, or how the contribution will be used. In some implementations, the additional information hyperlink 534 may be a help hyperlink that provides help on various features of the interface.

The accept/cancel control objects 536 may be a pair of interface control elements whereby the user, by tapping on a touchscreen, selecting/clicking via a pointer, etc., can authorize the transfer and allow the process to proceed to the next step, or cancel the transfer and thereby abort the process. Selecting one or the other of the accept/cancel control objects 536 may send an indication of the selection to the provider service of the software application, whereupon the provider service may continue with performing the process (if the user accepted) or cancel performance of the process (if the user selected “Cancel”).

Note that the interface 500 is meant to be illustrative only, and it is contemplated that such an interface may vary from the interface 500 depicted in FIG. 5. For example, the interface 500 may have more or fewer user interface elements and may have additional or different functionality than that depicted and described above. For example, although it is contemplated that the software application may be one that enables a transfer between two or more parties, it is contemplated that other types of processes may be triggered by fulfilment of a filter rule in a message on an interactive multiuser computer service platform, and therefore such other processes may necessitate different types of interface functionality.

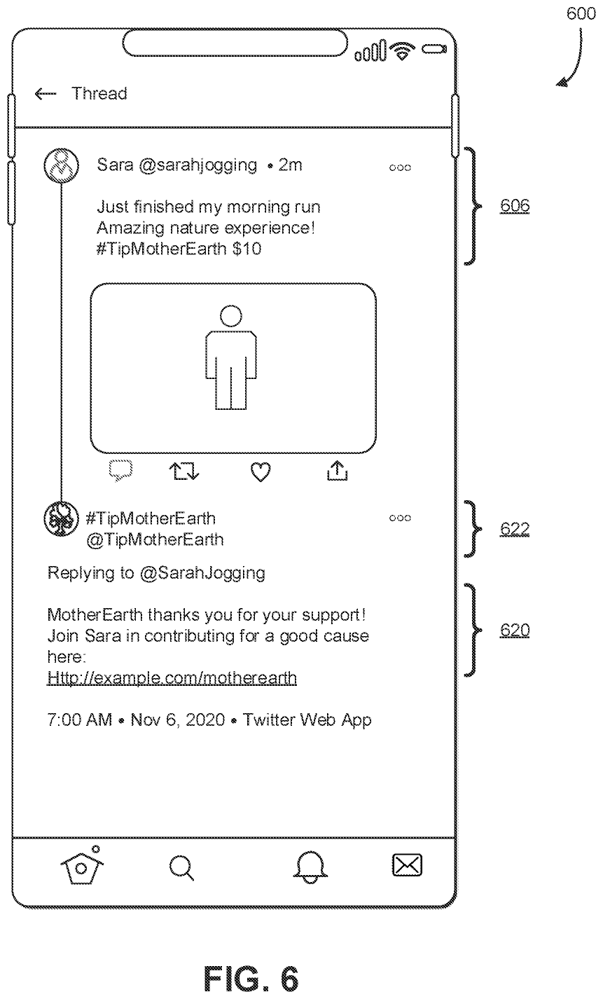

FIG. 6 illustrates an interface 600 on a client device in accordance with an embodiment of the present disclosure. Specifically, FIG. 6 depicts the interface 200 of FIG. 2 at a time after the user has accepted the proposed transfer in the interface 500 of FIG. 5. That is, upon receiving an indication of the user's acceptance of the transfer, the provider service responds to a first message 606 posted by the user with a second message 620 acknowledging completion of the transfer process.

As noted above, the interface 600 may be the interface 200 of FIG. 2 at a later point in time. That is, the interface 600 may be an interface provided by an interactive multiuser computer service, such as the interactive multiuser computer service 108 of FIG. 1, for display on a client device, such as the client device 104. The first message 606 may be the same message as the message 206 of FIG. 2.

The metadata tag 622 may indicate that the second message 620 is provided on behalf of the entity of the transfer in response to the metadata tag 622 included in the first message 606. The second message 620 may be similar to the second message 120 of FIG. 1, and may be a reply/comment to the first message 606 from a provider service similar to the provider service 112. As seen in the illustrative example of FIG. 6, the second message 620 expresses gratitude from an entity, similar to the entity 116, for the user having completed the transfer. In the illustrative example, the second message 620 also urges other users of the interactive multiuser computer service to participate in their own transfers and includes a hyperlink for doing so. In this manner, the second message 620 simultaneously authenticates the contribution claimed by the user in the first message 606, increases the repute of the user, and furthers the worthy cause.

Although not depicted in FIG. 6, had the user selected “Cancel” in the interface 500 of FIG. 5, the second message 620 may express something different. For example, in such a case the second message 620 may have read, “Transfer cancelled before completion.” In this manner, other users of the interactive multiuser computer service do not get an incorrect impression that the user completed the transfer. Alternatively, if an amount of time allotted to the user to authorize or cancel the transfer expires, the second message 620 may instead read “Transfer was not authorized within the allotted time” or some similar message. Or if some time still remains to authorize or cancel, alternatively, the second message 620 may instead read something similar to, “XX minutes remain to authorize the transfer or it will automatically be cancelled.”

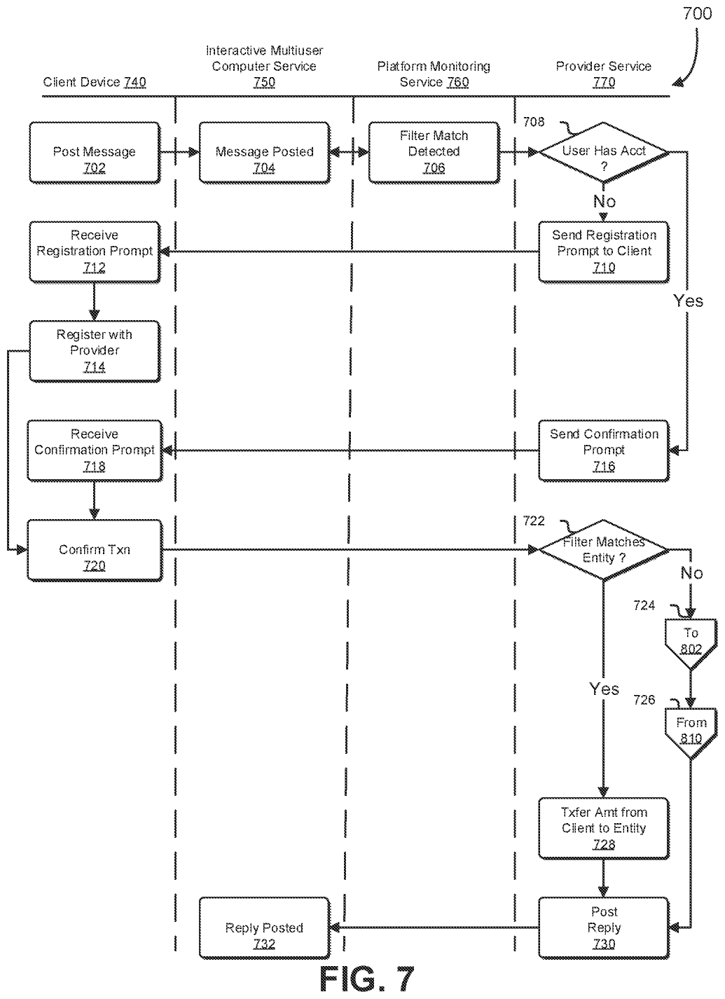

FIG. 7 is a swim diagram illustrating an example of a process 700 for performing a third-party-enabled transfer in accordance with various embodiments. Some or all of the process 700 (or any other processes described, or variations and/or combinations of those processes) may be performed under the control of one or more computer systems configured with executable instructions and/or other data, and may be implemented as executable instructions executing collectively on one or more processors. The executable instructions and/or other data may be stored on a non-transitory computer-readable storage medium (e.g., a computer program persistently stored on magnetic, optical, or flash media). For example, some or all of process 700 may be performed by any suitable system, such as the computing device 1500 of FIG. 15. The process 700 includes a series of operations wherein a user posts a message via a client device 740 to an interactive multiuser computer service platform 750, a platform monitoring service 760 detects that the message contains a match to a filter rule and notifies a provider service 770.

The client device 740 may be similar to the client device 104 of FIG. 1. The interactive multiuser computer service may be similar to the interactive multiuser computer service 108. The platform monitoring service 760 may be similar to the monitoring service 110. As discussed in the present disclosure, the platform monitoring service 760 may be able to, such as through application programming interfaces exposed by the interactive multi user computer service to the platform monitoring service, monitor/track forums, pages, and other records/messages posted by users on the interactive multiuser computer service platform. The provider service 770 may be similar to the provider service 112.

In 702, the user uploads a message to the interactive multiuser computer service via the client device 740. The message may include a metadata tag and/or other characters or values that match a filter rule being monitored for on the interactive multiuser computer service by the platform monitoring service.

In 704, the interactive multiuser computer service, having received the message, posts the message on its platform. The message may be posted on a public forum accessible to all or on a private forum of the interactive multiuser computer service accessible to a limited number of users and the platform monitoring service. An example of such a posted message can be seen in the interface 200 of FIG. 2.

In 706, in the course of monitoring the interactive multiuser computer service platform, the platform monitoring service detects, in the message, a filter match (a match to a filter rule) provided to the platform monitoring service by the provider service. As a result of detecting the filter match, the platform monitoring service notifies the provider service of the match. The notification sent by the platform monitoring service to the provider service may include an identifier identifying the filter rule whose match was detected so that the provider service can match the filter rule to its corresponding entity.

In 708, the provider service determines if the user whose set of user records is associated with the message posted on the interactive multiuser computer service platform has a set of user records with the provider service. If the user does not have a set of user records with the provider service, the provider service may proceed to perform 710 and respond to the message posted by the user on the interactive multiuser computer service platform or direct message the user on the interactive multiuser computer service to register with the provider service in order to complete the transfer initiated by the answer.

In 712, the client device receives the prompt from the provider service for the user to register with the provider service. In 714, the user and the provider service perform a registration process (not pictured) to register the user with a set of user records with the provider service. Once the user has a set of user records set up with the provider service, the client device may proceed to 720, whereupon the user is prompted to confirm the transfer initiated with the message in 702.

However, if the user is registered with the provider service, in 716, the provider service may send a confirmation notification to prompt the user to confirm whether to proceed with the transfer initiated in 702. In 718, the client device notifies the user of the confirmation notification from the provider service, such as via the interface 400 of FIG. 4. In 720, the client device may receive input from the user accepting or cancelling the transfer, such as through the interface 500 of FIG. 5. Presuming that the user elects to proceed with the transfer, the client device provides an indication to the provider service of the user's acceptance of the transfer.

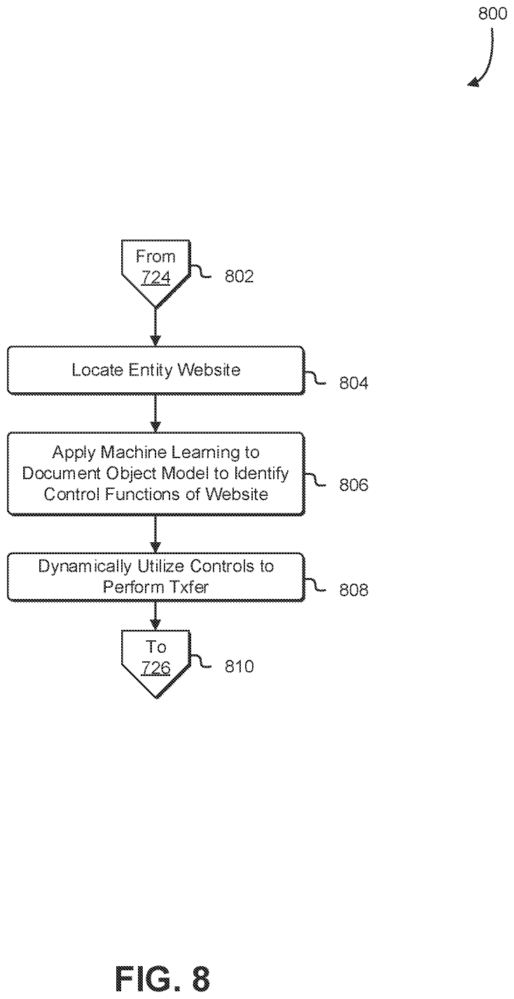

In 722, the provider service determines whether the metadata tag and or other symbols that match the filter rule correspond to an entity registered with the provider service. If yes, the provider service proceeds to perform the operations of 728 to complete the transfer. If no, the process performed by the provider service may proceed to 724 to perform an entity interface process to complete the transfer through an interface (e.g., a website) of the entity (e.g., the process 800 of FIG. 8). In 726, the provider service returns from the entity interface process and proceeds to 730.

In 728, the provider service completes the transfer with the entity. For example, the provider service may enable the transfer by transferring an amount corresponding to the amount indicated in the message of 702 from the user's set of user records to the provider service, and transferring the same amount from the provider service to the entity. In 730, the provider service responds to the message posted with the interactive multiuser computer service in 704 with the reply indicating completion of the process initiated in 702. In response, in 732, the interactive multiuser computer service posts the reply on its platform. An example of the reply can be seen with the second message 620 of FIG. 6.

Note that one or more of the operations performed in 702-32 may be performed in various orders and combinations, including in parallel. For example, in some implementations, the operations of 722-26 may be performed prior to or in parallel with the operations of 708-20.

FIG. 8 is a flowchart illustrating an example of a process 800 for performing a transfer with an entity in accordance with various embodiments. Some or all of the process 800 (or any other processes described, or variations and/or combinations of those processes) may be performed under the control of one or more computer systems configured with executable instructions and/or other data, and may be implemented as executable instructions executing collectively on one or more processors. The executable instructions and/or other data may be stored on a non-transitory computer-readable storage medium (e.g., a computer program persistently stored on magnetic, optical, or flash media). For example, some or all of process 800 may be performed by any suitable system, such as the computing device 1500 of FIG. 15. The process 800 includes a series of operations wherein a website of the entity is located, the control objects and their functions are identified, and the control objects are dynamically utilized to perform the transfer. It is contemplated that the process 800 may be performed by a provider service, such as the provider service 112 of FIG. 1 or the provider service 770 of FIG. 7. It is further contemplated that the operations of 804-08 may be performed independently or may be performed as part of the process 700 of FIG. 7. For this reason, the flowchart is depicted to continue from 710 in 802.

In 804, the system performing the process 700 determines an address of a website corresponding to the entity. It is contemplated that this determination may be made in a variety of ways, such as a list that the provider service has compiled mapping entities to the respective websites or by implementing a software agent, such as an Internet bot, to dynamically utilize an Internet search engine using an application programming interface provided by the search engine provider service or by simulating human interaction with the Internet search engine, to perform a search on the name of the entity. For example, in FIG. 3 the illustrative example of the metadata tag 322 is “#TipMotherEarth.” Based on this information, the provider service may utilize the Internet search engine to search for terms such as “tipmotherearth,” “motherearth,” “mother earth,” and so on. The software agent may then follow the Uniform Resource Locators (URLs) in the search results to determine the most likely candidate to be the website of the entity.

The website of the entity may be unfamiliar to the provider service, and the manner in which value may be transferred from the provider service to the entity may not immediately be known to the provider service. Thus, in 806, the system performing the process 800 may utilize a machine learning algorithm in the manner described in U.S. patent application Ser. No. 16/744,017, U.S. patent application Ser. No. 16/744,021, U.S. Pat. No. 10,846,106, U.S. patent application Ser. No. 17/101,744, U.S. patent application Ser. No. 16/680,392, U.S. patent application Ser. No. 16/680,396, U.S. patent application Ser. No. 16/680,403, U.S. patent application Ser. No. 16/680,406, U.S. patent application Ser. No. 16/680,408, and U.S. patent application Ser. No. 16/680,410, fully incorporated by reference above, to identify the control functions of the website of the entity.

In 808, the system performing the process 800 utilizes the results of the machine learning algorithm of 806 to interact, such as by simulating human interaction with the elements of the interface determined usable to transfer the value from the provider service to the entity. In some examples, simulating human interaction (also referred to as performing simulated human interaction) refers to dynamically simulating input events (e.g., OnClick, OnMouseOver, OnDblClick, OnSelect, OnTouchStart, OnDrag, OnSubmit, etc. events) without human intervention. In 810, the system performing the process returns to 726 of FIG. 7. Note that one or more of the operations performed in 802-10 may be performed in various orders and combinations, including in parallel.

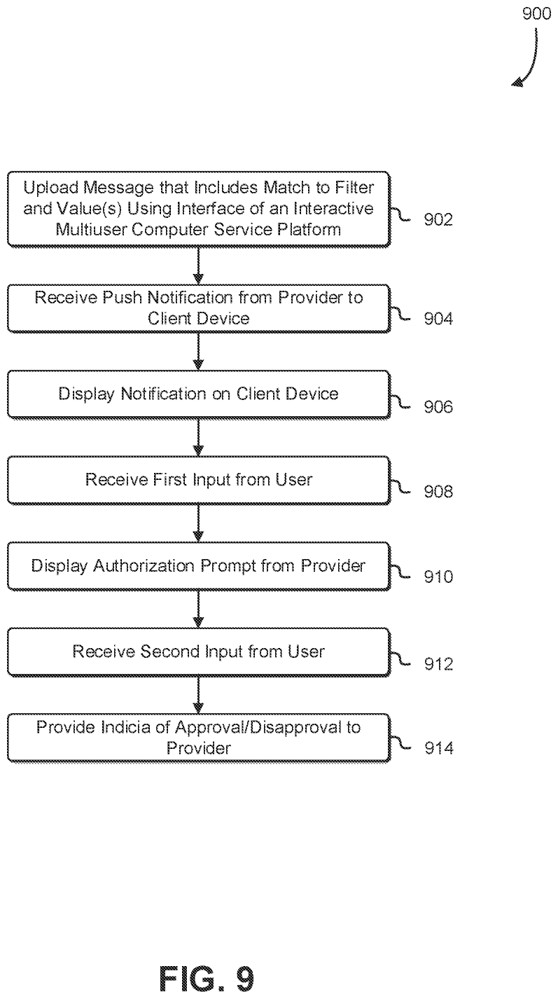

FIG. 9 is a flowchart illustrating an example of a process 900 performed by a client device under the control of a user in accordance with various embodiments. Some or all of the process 900 (or any other processes described, or variations and/or combinations of those processes) may be performed under the control of one or more computer systems configured with executable instructions and/or other data, and may be implemented as executable instructions executing collectively on one or more processors. The executable instructions and/or other data may be stored on a non-transitory computer-readable storage medium (e.g., a computer program persistently stored on magnetic, optical, or flash media). For example, some or all of process 900 may be performed by any suitable system, such as the computing device 1500 of FIG. 15. The process 900 includes a series of operations wherein the user inputs a message that includes a match to a filter rule, and, in response, the client device receives a notification from a provider service to launch a software application on the client device. Upon receiving input from the user, the client device launches the software application to display an authorization prompt from the provider service, accept second input from the user, and provide the second input to the provider service.

In 902, the client device having received a message input by the user through an interface of the client device, uploads the message to an interactive multiuser computer service platform. The message may be similar to the first message 106 of FIG. 1 and may include a metadata tag and/or other symbols or values that match a filter rule being monitored by a monitoring service, such as the monitoring service 110. The monitoring service may, upon detecting the metadata tag and/or other symbols or values, notify a provider service, such as the provider service 112, of the filter rule match.

In 904, after the upload of the message to the interactive multiuser computer service, the client device may receive a notification, such as the notification 118 of FIG. 1 pushed by a provider service, such as the provider service 112. The notification may trigger the client device, in 906, to display the notification to alert the user that further input is needed from the user. The display of the notification may further include a request for input from the user to launch a software application on the client device, such as a software application provided by the provider service for enabling the process initiated by the user's inclusion of the metadata tag and/or other symbols or values in the message of 902. An example of such a display is depicted in the interface 400 of FIG. 4.

In 908, the client device receives input from the user to proceed with the next portion of the process. For example, the user may select the “Click Here” hyperlink on the interface 400 of FIG. 4 to cause a software application to launch on the client device. The first input may be received via the user tapping a touch screen, moving an input device, issuing a voice command, or other method of providing input to the client device.

Receipt of the input from the user may cause the client device to display, in 910, an authorization prompt for the provider service. The authorization prompt may prompt the user to authorize the provider service to proceed with the process initiated by the user in the message of 902. An example of such an authorization prompt is the interface 500 of FIG. 5.

In 912, the client device receives input from the user, such as an input indicating acceptance or cancellation of the transfer depicted in the interface 500 of FIG. 5. As with the first input in 908, the second input may be received via the user tapping a touch screen, moving an input device, issuing a voice command, or other method of providing input to the client device. In 914, the client device sends an indication to the provider service indicating the user's response based on the second input received in 912. Note that one or more of the operations performed in 902-14 may be performed in various orders and combinations, including in parallel.

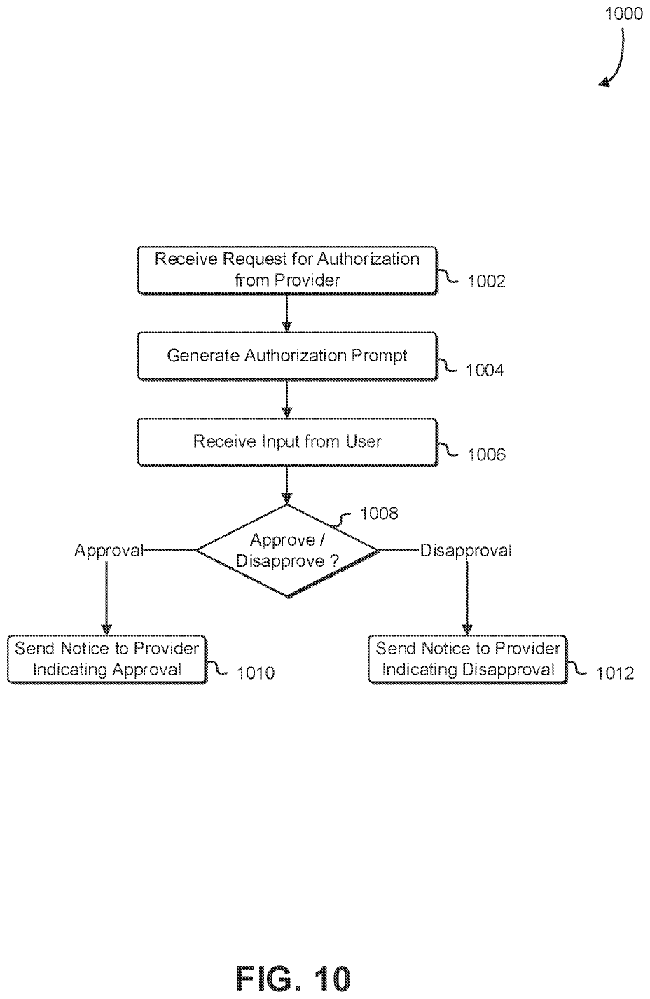

FIG. 10 is a flowchart illustrating an example of a process 1000 performed by a software application provided by the provider service and running on the client device in accordance with various embodiments. Some or all of the process 1000 (or any other processes described, or variations and/or combinations of those processes) may be performed under the control of one or more computer systems configured with executable instructions and/or other data, and may be implemented as executable instructions executing collectively on one or more processors. The executable instructions and/or other data may be stored on a non-transitory computer-readable storage medium (e.g., a computer program persistently stored on magnetic, optical, or flash media). For example, some or all of process 1000 may be performed by any suitable system, such as the computing device 1500 of FIG. 15. The process 1000 includes a series of operations wherein a request is received from a provider service to authorize proceeding with the process, a screen to prompt the user to authorize is generated, input is received from the user, and based on whether the user authorizes or disallows, and a notification is sent to the provider service indicating such.

In 1002, the software application executing on the client device receives information from the client device or from the provider service indicating that the provider service has sent a notification to the client device for the user to authorize whether or not to proceed with the process. The software application may receive the information as a result of a user selecting to proceed with the authorization from a notification screen, such as the interface 400 of FIG. 4.

In 1004, the software application executing on the client device generates and displays an interface on a screen of the client device with functionality to allow the user to authorize proceeding with the process or to disallow preceding with the process. An example of the interface is the interface 500 of FIG. 5.

In 1006, the software application executing on the client device receives a selection from the user through the interface, such as via touchscreen input, movement of an input device, voice command, or other such input, the input indicating approval or disapproval of proceeding with the process. In 1008, the software application determines which of either approval or disapproval the input received from the user in 1006 corresponds to. If the input indicated approval, the software application proceeds to 1010 and provides a notification to the provider service that the user selected to authorize proceeding with the process. On the other hand, if the input indicated disapproval, the software application proceeds to 1012 and provides a notification to the provider service that the user elected to cancel proceeding with the process. Note that one or more of the operations performed in 1002-12 may be performed in various orders and combinations, including in parallel.

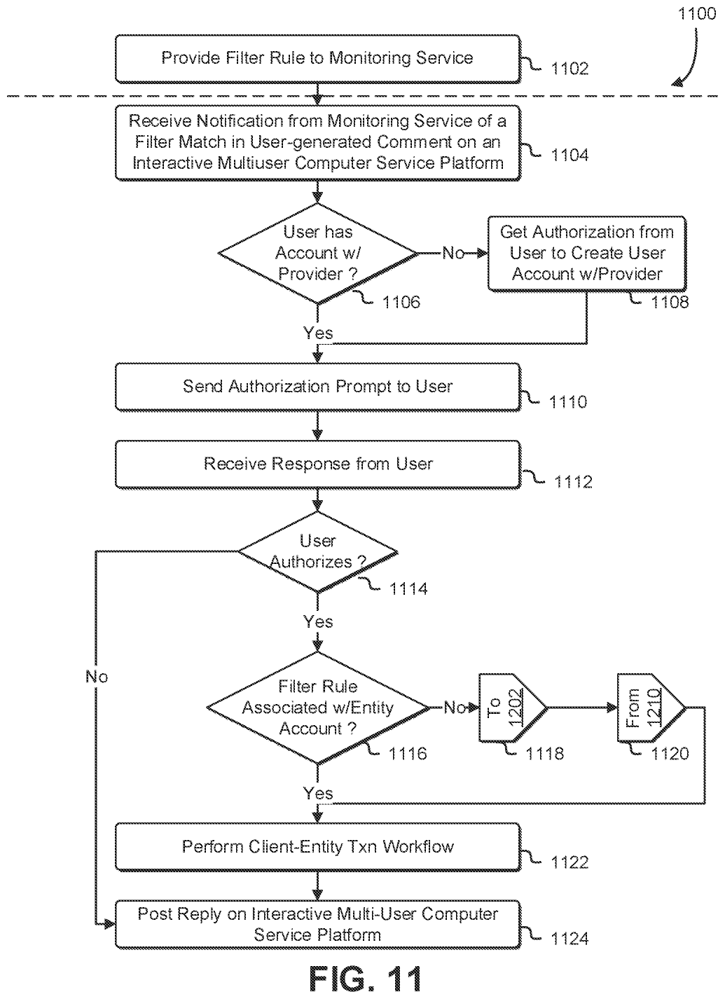

FIG. 11 is a flowchart illustrating an example of a process 1100 for a provider service to perform a transfer process in accordance with various embodiments. Some or all of the process 1100 (or any other processes described, or variations and/or combinations of those processes) may be performed under the control of one or more computer systems configured with executable instructions and/or other data, and may be implemented as executable instructions executing collectively on one or more processors. The executable instructions and/or other data may be stored on a non-transitory computer-readable storage medium (e.g., a computer program persistently stored on magnetic, optical, or flash media). For example, some or all of process 1100 may be performed by any suitable system, such as the computing device 1500 of FIG. 15. The process 1100 includes a series of operations wherein a filter rule is provided to a monitoring service, and sometime later a notification is received from the monitoring service that a match to the filter rule was detected in a user generated comment on an interactive multiuser computer service. A determination is made whether the user who generated the comment has a set of user records with the provider service, and if so, an authorization prompt to perform a transfer process is sent to the user, whereupon a determination is made whether the user has authorized the transfer process to be performed. Based on the filter rule, a determination is made whether the entity is registered with the provider service, the client-entity process is performed, and a reply is posted on the interactive multiuser computer service. The process 1100 may be performed by a provider service, such as the provider service 112 of FIG. 1 or the provider service 770 of FIG. 7

In 1102, the provider service provides a filter rule to a monitoring service. The filter rule may be a set of criteria for determining whether a string of characters is found within a shared message on an interactive multiuser computer service platform forum. As noted above, the filter rule may be structured as a regular expression or some other rule for identifying matching strings of characters. The dashed line between 1102 and 1104 indicates that the operations of 1102 may be performed asynchronously and at some time earlier to those of 1104-24.

In 1104, the provider service receives a notification from the monitoring service that a match to the filter rule provided to the monitoring service by the provider service was found in a message associated with a user on an interactive multiuser computer service platform. In 1106, the provider service determines whether the user associated with the message has a set of user records with the provider service. If not, in 1108, the provider service contacts (e.g., via direct message through the interactive multiuser computer service) the user requesting that the user establish a set of user records with the provider service for the client-entity process to proceed. The process for creating a set of user records for the user is not depicted, for brevity.

In 1110, having created or confirmed the set of user records for the user, the provider service pushes a notification and/or authorization prompt to a client device of the user (e.g., the client device may be registered with the set of user records of the user at the provider) to accept or cancel the client-entity process initiated by the user's message with the match to the filter rule detected in 1104. An example of the notification and authorization prompt may be seen in the interfaces 400 and 500 of FIGS. 4 and 5 respectively. In 1112, the provider service receives the response to the authorization prompt from the user.

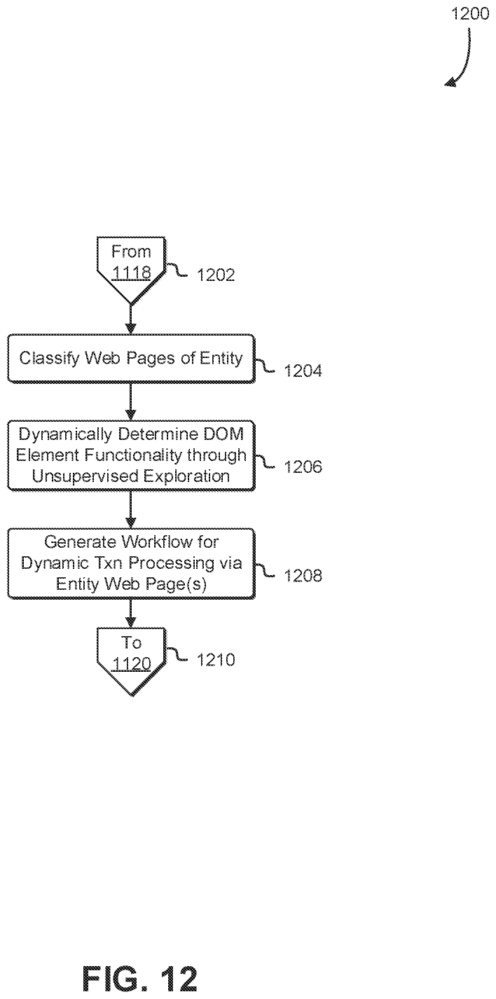

In 1114, the provider service determines which of either authorization or cancellation is indicated by the response from the user. If cancellation is indicated, the provider service may proceed to 1124 to respond to the message on the interactive multiuser computer service with a second message indicating that the client-entity process was cancelled (e.g., “Transfer cancelled”). On the other hand, if the acceptance was indicated, in 1116, the provider service determines whether the entity associated with the filter rule has a set of user records with the provider service. If not, the provider service may proceed to 1118 to perform a process to dynamically explore and classify a website of the entity in order to determine how to enable the transfer using the entity's website. An example of this process can be seen in FIG. 12. In 1120, the provider service returns from the exploration and classification process of FIG. 12 and proceeds to 1122.

In 1122, the provider service enables the client-entity transfer. For example, the provider service may perform a transfer of value from the client set of user records to the provider service, and then perform a transfer of value from the provider service to a set of user records of the entity (or vice versa as applicable, depending on the type of transfer). In situations where the entity does not have a set of user records registered with the provider service (e.g., see 1116-20), the entity may utilize a machine learning algorithm that has been developed to interact with the entity's website to complete the transfer (see 804-08 of FIG. 8).

Lastly, in 1124, the provider service replies to the message of 1104 on the interactive multiuser computer service platform in which the match to the filter rule was detected. If the transfer was successfully completed, the reply may include words to that effect. If the transfer was not successfully completed, the reply may likewise indicate such. An example of such a reply is the second message 622 of FIG. 6. Note that one or more of the operations performed in 1102-24 may be performed in various orders and combinations, including in parallel. For example, in some implementations the operations of 1116-20 may be performed prior to or in parallel with the operations of 1106-14.

FIG. 12 is a flowchart illustrating an example of a process 1200 classifying an interface (e.g., a website) in accordance with various embodiments. Some or all of the process 1200 (or any other processes described, or variations and/or combinations of those processes) may be performed under the control of one or more computer systems configured with executable instructions and/or other data, and may be implemented as executable instructions executing collectively on one or more processors. The executable instructions and/or other data may be stored on a non-transitory computer-readable storage medium (e.g., a computer program persistently stored on magnetic, optical, or flash media). For example, some or all of process 1200 may be performed by any suitable system, such as the computing device 1500 of FIG. 15. The process 1200 includes a series of operations wherein web pages of an entity are classified, functionality of the objects within the web pages are determined, and a process for processing a transfer using the web pages is generated. The process 1200 may be performed by a provider service, such as the provider service 112 of FIG. 1 or the provider service 770 of FIG. 7.

In 1202, the provider service begins the process from 1118 in FIG. 11. In 1204, the provider service performs a process to classify different types of web pages of the entity that are accessible through the Internet. Techniques for classifying web pages may be found in U.S. patent application Ser. No. 16/744,017, U.S. patent application Ser. No. 16/744,021, and U.S. Pat. No. 10,846,106, fully incorporated by reference above.

In 1206, the provider service determines the functionality of the various document object model (DOM) elements in the web pages. Techniques for unsupervised exploration to determine such element functionality may be found in U.S. patent application Ser. No. 17/101,744, U.S. patent application Ser. No. 16/680,392, U.S. patent application Ser. No. 16/680,396, U.S. patent application Ser. No. 16/680,403, U.S. patent application Ser. No. 16/680,406, U.S. patent application Ser. No. 16/680,408, and U.S. patent application Ser. No. 16/680,410, fully incorporated by reference above.

In 1208, having determined the functionality of the elements on the web pages, the provider service generates a process usable by the provider service to make a transfer of value from the provider service to the entity. The provider service then may implement the process in 1122. In 1210, the provider service may return to 1120 of FIG. 11. Note that one or more of the operations performed in 1202-10 may be performed in various orders and combinations, including in parallel. For example, the process 1200 may be performed prior to and independent from the process 1100 of FIG. 11, and when performance of the process 1100 reaches the operations of 1118, the process 1200 may already be complete and the process 1200 may be omitted.

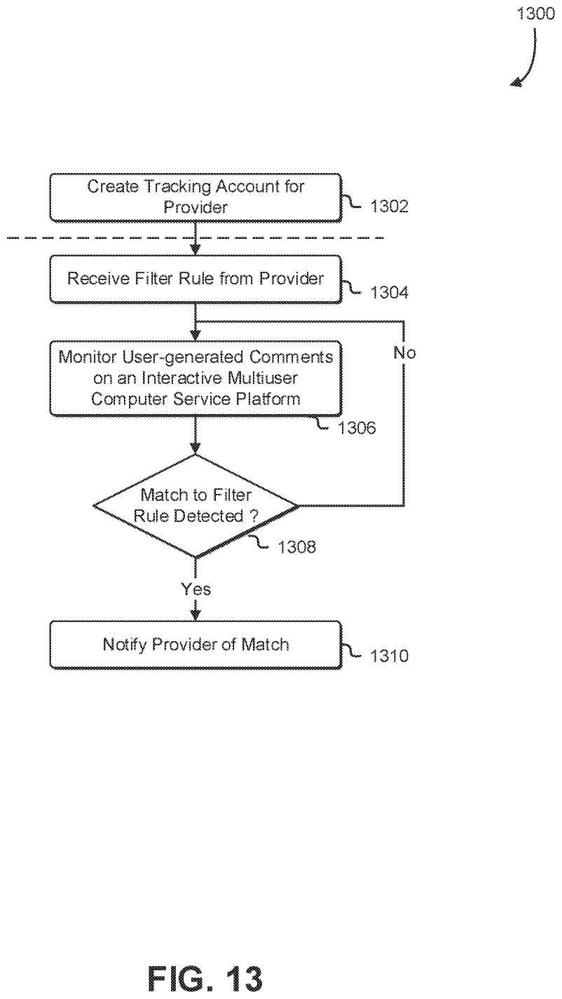

FIG. 13 is a flowchart illustrating an example of a process 1300 for monitoring an interactive multiuser computer service platform for a match to a filter rule in accordance with various embodiments. Some or all of the process 1300 (or any other processes described, or variations and/or combinations of those processes) may be performed under the control of one or more computer systems configured with executable instructions and/or other data, and may be implemented as executable instructions executing collectively on one or more processors. The executable instructions and/or other data may be stored on a non-transitory computer-readable storage medium (e.g., a computer program persistently stored on magnetic, optical, or flash media). For example, some or all of process 1300 may be performed by any suitable system, such as the computing device 1500 of FIG. 15. The process 1300 includes a series of operations wherein a set of user records is created for the provider service, a filter rule is received from the provider service, the interactive multiuser computer service platform is monitored for an occurrence of the filter rule, and the provider service is notified when a match to the filter rule is detected. The process 1300 may be performed by a third-party platform monitoring service, such as the monitoring services 110 or 310 of FIGS. 1 and 3 or the platform monitoring service 760 of FIG. 7.

The platform monitoring service may be a service available to others to track metadata tags, such as hashtags, posted on forums of an interactive multiuser computer service. The platform monitoring service may have been provided access to the interactive multiuser computer service platform for this purpose. Thus, in 1302, the platform monitoring service may receive a request from a provider service to establish a set of user records with the platform monitoring service and, in response, may create a set of user records at the platform monitoring service for the provider service. Note that the dashed line between 1302 and 1304 indicates that the operations of 1302 may be performed asynchronously and at some time earlier to those of 1304-10.

In 1304, the monitoring service receives a filter rule from the provider service. As noted, the filter rule may be associated with an entity registered with the provider service. The filter rule may be specific to a particular combination of characters, such as a metadata tag and/or symbols or values. In 1306, the monitoring service monitors various forums of the interactive multiuser computer service. In 1308, the monitoring service determines whether, during monitoring the interactive multiuser computer service forums, a previously undetected (by the monitoring service) occurrence of a set of characters that matches the filter rule provided by the provider service in 1304 has been detected. If not, the monitoring service returns to 1306 to continue monitoring the interactive multiuser computer service forums.

On the other hand, if the monitoring service finds a match to the filter rule, in 1310, the monitoring service sends a notification to the provider service that the match was found. The notification may include information such as information identifying the filter rule that was matched, an identifier for the message that contains the characters that matched the filter rule, and information identifying the user who posted the message containing the characters that matched the filter rule. Note that one or more of the operations performed in 1302-10 may be performed in various orders and combinations, including in parallel.

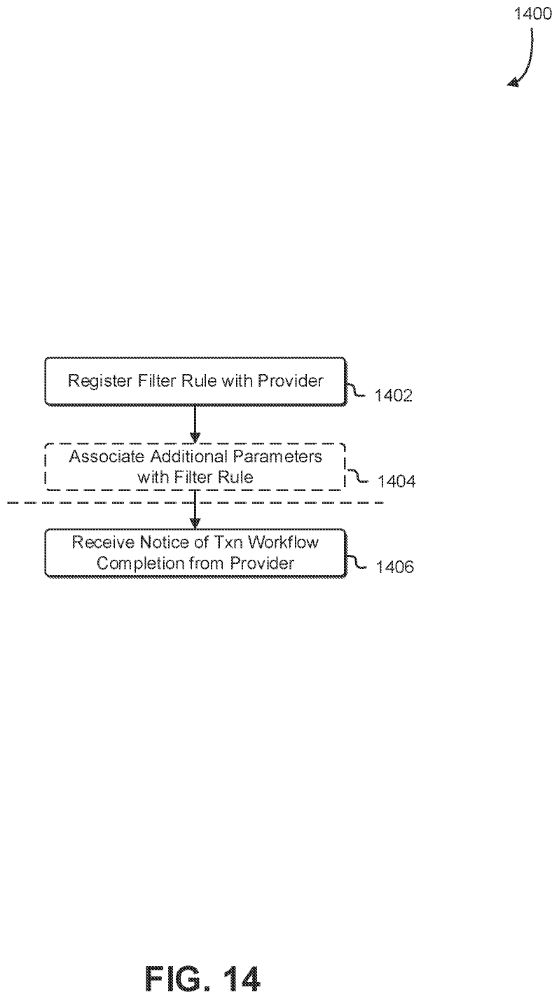

FIG. 14 is a flowchart illustrating an example of a process 1400 for an entity to register a filter rule with a provider service in accordance with various embodiments. Some or all of the process 1400 (or any other processes described, or variations and/or combinations of those processes) may be performed under the control of one or more computer systems configured with executable instructions and/or other data, and may be implemented as executable instructions executing collectively on one or more processors. The executable instructions and/or other data may be stored on a non-transitory computer-readable storage medium (e.g., a computer program persistently stored on magnetic, optical, or flash media). For example, some or all of process 1400 may be performed by any suitable system, such as the computing device 1500 of FIG. 15. The process 1400 includes a series of operations wherein a filter rule is registered with the provider service, additional parameters are optionally associated with the filter rule, and a notification that a transfer has been completed is received. The process 1400 may be performed by an entity, such as the entity 116 of FIG. 1.

In 1402, the entity performing the process 1400 may register a filter rule with the provider service. In this way, the provider service can correlate the filter rule with the entity and vice versa. The filter rule and the correlation may be stored in a data store, such as the data store 114 of FIG. 1. Subsequently, the provider service may register the filter rule with a monitoring service (e.g., the operations of 1102 of FIG. 11 and process 1300 of FIG. 13). As noted in the present disclosure, the filter rule may specify a particular combination of characters and/or other symbols or values. For example, the filter rule may be a particular regular expression. The entity may have multiple filter rules, with each corresponding to a different purpose for the entity, and the particular purpose to which the filter rule corresponds may additionally be registered with the provider service in correlation with the filter rule.

In 1404, additional parameters may be associated with the filter rule. Additional parameters may specify limitations for the filter rule, such as an expiration date, date/time ranges when the filter rule is valid, minimum or maximum amounts for the transfer, eligibility requirements for users of the interactive multiuser computer service to participate with the program associated with the filter rule, and so on.

Note that the dashed line between 1404 and 1406 indicates that the operations of 1302-04 may be performed asynchronously and at some time earlier to those of 1306. In 1406, the entity may receive from the provider service an indication that the filter rule was matched and a transfer completed (e.g., the process 1124 of FIG. 11). The indication may be in the form of a message from the provider service or may be in the form of an addition of value to a set of user records of the entity. Note that one or more of the operations performed in 1402-06 may be performed in various orders and combinations, including in parallel.

Note that, in the context of describing disclosed embodiments, unless otherwise specified, use of expressions regarding executable instructions (also referred to as code, applications, agents, etc.) performing operations that “instructions” do not ordinarily perform unaided (e.g., transmitting data, computations, etc.) denotes that the instructions are being executed by a machine, thereby causing the machine to perform the specified operations.

FIG. 15 is an illustrative, simplified block diagram of a computing device 1500 that can be used in at least one embodiment of the present disclosure. In various embodiments, the computing device 1500 includes any appropriate device operable to send and/or receive requests, messages, or information over an appropriate network and convey information back to a user of the device. The computing device 1500 may be used to implement any of the systems depicted and described above. For example, the computing device 1500 may be configured for use as a data server, a web server, a portable computing device, a personal computer, a cellular or other mobile phone, a handheld messaging device, a laptop computer, a tablet computer, a set-top box, a personal data assistant, an embedded computer system, an electronic book reader, or any electronic computing device. The computing device 1500 may be implemented as a hardware device, a virtual computer system, or one or more programming modules executed on a computer system, and/or as another device configured with hardware and/or software to receive and respond to communications (e.g., web service application programming interface (API) requests) over a network.

As shown in FIG. 15, the computing device 1500 may include one or more processors 1502 that, in embodiments, communicate with and are operatively coupled to a number of peripheral subsystems via a bus subsystem. In some embodiments, these peripheral subsystems include a storage subsystem 1506, comprising a memory subsystem 1508 and a file/disk storage subsystem 1510, one or more user interface input devices 1512, one or more user interface output devices 1514, and a network interface subsystem 1516. Such storage subsystem 1506 may be used for temporary or long-term storage of information.

In some embodiments, the bus subsystem 1504 may provide a mechanism for enabling the various components and subsystems of computing device 1500 to communicate with each other as intended. Although the bus subsystem 1504 is shown schematically as a single bus, alternative embodiments of the bus subsystem utilize multiple buses. The network interface subsystem 1516 may provide an interface to other computing devices and networks. The network interface subsystem 1516 may serve as an interface for receiving data from and transmitting data to other systems from the computing device 1500. In some embodiments, the bus subsystem 1504 is utilized for communicating data such as details, search terms, and so on. In an embodiment, the network interface subsystem 1516 may communicate via any appropriate network that would be familiar to those skilled in the art for supporting communications using any of a variety of available protocols, such as Transmission Control Protocol/Internet Protocol (TCP/IP), User Datagram Protocol (UDP), protocols operating in various layers of the Open System Interconnection (OSI) model, File Transfer Protocol (FTP), Universal Plug and Play (UpnP), Network File System (NFS), Common Internet File System (CIFS), and other protocols.

The network, in an embodiment, is a local area network, a wide-area network, a virtual private network, the Internet, an intranet, an extranet, a public switched telephone network, a cellular network, an infrared network, a wireless network, a satellite network, or any other such network and/or combination thereof, and components used for such a system may depend at least in part upon the type of network and/or system selected. In an embodiment, a connection-oriented protocol is used to communicate between network endpoints such that the connection-oriented protocol (sometimes called a connection-based protocol) is capable of transmitting data in an ordered stream. In an embodiment, a connection-oriented protocol can be reliable or unreliable. For example, the Transmission Control Protocol (TCP) is a reliable connection-oriented protocol. Asynchronous Transfer Mode and Frame Relay are unreliable connection-oriented protocols. Connection-oriented protocols are in contrast to packet-oriented protocols such as UDP that transmit packets without a guaranteed ordering. Many protocols and components for communicating via such a network are well known and will not be discussed in detail. In an embodiment, communication via the network interface subsystem 1516 is enabled by wired and/or wireless connections and combinations thereof.

In some embodiments, the user interface input devices 1512 includes one or more user input devices such as a keyboard; pointing devices such as an integrated mouse, trackball, touchpad, or graphics tablet; a scanner; a code scanner; a touch screen incorporated into the display; audio input devices such as voice recognition systems, microphones; and other types of input devices. In general, use of the term “input device” is intended to include all possible types of devices and mechanisms for inputting information to the computing device 1500. In some embodiments, the one or more user interface output devices 1514 include a display subsystem, a printer, or non-visual displays such as audio output devices, etc. In some embodiments, the display subsystem includes a cathode-ray tube (CRT), a flat-panel device such as a liquid crystal display (LCD), light emitting diode (LED) display, or a projection or other display device. In general, use of the term “output device” is intended to include all possible types of devices and mechanisms for outputting information from the computing device 1500. The one or more user interface output devices 1514 can be used, for example, to present user interfaces to enable user interaction with applications performing processes described and variations therein, when such interaction may be appropriate.

In some embodiments, the storage subsystem 1506 provides a computer-readable storage medium for storing the basic programming and data constructs that provide the functionality of at least one embodiment of the present disclosure. The applications (programs, code modules, instructions), when executed by one or more processors in some embodiments, provide the functionality of one or more embodiments of the present disclosure and, in embodiments, are stored in the storage subsystem 1506. These application modules or instructions can be executed by the one or more processors 1502. In various embodiments, the storage subsystem 1506 additionally provides a repository for storing data used in accordance with the present disclosure. In some embodiments, the storage subsystem 1506 comprises a memory subsystem 1508 and a file/disk storage subsystem 1510.

In embodiments, the memory subsystem 1508 includes a number of memories, such as a main random access memory (RAM) 1518 for storage of instructions and data during program execution and/or a read-only memory (ROM) 1520, in which fixed instructions can be stored. In some embodiments, the file/disk storage subsystem 1510 provides a non-transitory persistent (non-volatile) storage for program and data files and can include a hard disk drive, a floppy disk drive along with associated removable media, a Compact Disk Read Only Memory (CD-ROM) drive, an optical drive, removable media cartridges, or other like storage media.

In some embodiments, the computing device 1500 includes at least one local clock 1524. The at least one local clock 1524, in some embodiments, is a counter that represents the number of ticks that have transpired from a particular starting date and, in some embodiments, is located integrally within the computing device 1500. In various embodiments, the at least one local clock 1524 is used to synchronize data transfers in the processors for the computing device 1500 and the subsystems included therein at specific clock pulses and can be used to coordinate synchronous operations between the computing device 1500 and other systems in a data center. In another embodiment, the local clock is a programmable interval timer.

The computing device 1500 could be of any of a variety of types, including a portable computer device, tablet computer, a workstation, or any other device described below. Additionally, the computing device 1500 can include another device that, in some embodiments, can be connected to the computing device 1500 through one or more ports (e.g., USB, a headphone jack, Lightning connector, etc.). In embodiments, such a device includes a port that accepts a fiber-optic connector. Accordingly, in some embodiments, this device converts optical signals to electrical signals that are transmitted through the port connecting the device to the computing device 1500 for processing. Due to the ever-changing nature of computers and networks, the description of the computing device 1500 depicted in FIG. 15 is intended only as a specific example for purposes of illustrating the preferred embodiment of the device. Many other configurations having more or fewer components than the system depicted in FIG. 15 are possible.

The specification and drawings are, accordingly, to be regarded in an illustrative rather than a restrictive sense. However, it will be evident that various modifications and changes may be made thereunto without departing from the scope of the invention as set forth in the claims. Likewise, other variations are within the scope of the present disclosure. Thus, while the disclosed techniques are susceptible to various modifications and alternative constructions, certain depicted embodiments thereof are shown in the drawings and have been described above in detail. It should be understood, however, that there is no intention to limit the invention to the specific form or forms disclosed but, on the contrary, the intention is to cover all modifications, alternative constructions and equivalents falling within the scope of the invention, as defined in the appended claims.

In some embodiments, data may be stored in a data store (not depicted). In some examples, a “data store” refers to any device or combination of devices capable of storing, accessing, and retrieving data, which may include any combination and number of data servers, databases, data storage devices, and data storage media, in any standard, distributed, virtual, or clustered system. A data store, in an embodiment, communicates with block-level and/or object level interfaces. The computing device 1500 may include any appropriate hardware, software and firmware for integrating with a data store as needed to execute aspects of one or more applications for the computing device 1500 to handle some or all of the data access and logic for the one or more applications. The data store, in an embodiment, includes several separate data tables, databases, data documents, dynamic data storage schemes, and/or other data storage mechanisms and media for storing data relating to a particular aspect of the present disclosure. In an embodiment, the computing device 1500 includes a variety of data stores and other memory and storage media as discussed above. These can reside in a variety of locations, such as on a storage medium local to (and/or resident in) one or more of the computers or remote from any or all of the computers across a network. In an embodiment, the information resides in a storage-area network (SAN) familiar to those skilled in the art, and, similarly, any necessary files for performing the functions attributed to the computers, servers or other network devices are stored locally and/or remotely, as appropriate.

In an embodiment, the computing device 1500 may provide access to content including, but not limited to, text, graphics, audio, video, and/or other content that is provided to a user in the form of a Markup Language (e.g., HTML), Extensible Markup Language (XML), JavaScript, Cascading Style Sheets (CSS), JavaScript Object Notation (JSON), and/or another appropriate language. The computing device 1500 may provide the content in one or more forms including, but not limited to, forms that are perceptible to the user audibly, visually, and/or through other senses. The handling of requests and responses, as well as the delivery of content, in an embodiment, is handled by the computing device 1500 using PHP, Python, Ruby, Perl, Java, HTML, XML, JSON, and/or another appropriate language in this example. In an embodiment, operations described as being performed by a single device are performed collectively by multiple devices that form a distributed and/or virtual system.

In an embodiment, the computing device 1500 typically will include an operating system that provides executable program instructions for the general administration and operation of the computing device 1500 and includes a computer-readable storage medium (e.g., a hard disk, random access memory (RAM), read only memory (ROM), etc.) storing instructions that if executed (e.g., as a result of being executed) by a processor of the computing device 1500 cause or otherwise allow the computing device 1500 to perform its intended functions (e.g., the functions are performed as a result of one or more processors of the computing device 1500 executing instructions stored on a computer-readable storage medium).

In an embodiment, the computing device 1500 operates as a web server that runs one or more of a variety of server or mid-tier applications, including HTTP servers, FTP servers, Common Gateway Interface (CGI) servers, data servers, Java servers, Apache servers, and application servers. In an embodiment, computing device 1500 is also capable of executing programs or scripts in response to requests from user devices, such as by executing one or more web applications that are implemented as one or more scripts or programs written in any programming language, such as Java®, C, C# or C++, or any scripting language, such as Ruby, PHP, Perl, Python, or TCL, as well as combinations thereof. In an embodiment, the computing device 1500 is capable of storing, retrieving, and accessing structured or unstructured data. In an embodiment, computing device 1500 additionally or alternatively implements a database, such as one of those available from Oracle®, Microsoft®, Sybase®, and IBM® as well as open-source servers such as MySQL, Postgres, SQLite, MongoDB. In an embodiment, the database includes table-based servers, document-based servers, unstructured servers, relational servers, non-relational servers, or combinations of these and/or other database servers.

The use of the terms “a” and “an” and “the” and similar referents in the context of describing the disclosed embodiments (e.g., in the context of the following claims) is to be construed to cover both the singular and the plural, unless otherwise indicated or clearly contradicted by context. The terms “comprising,” “having,” “including” and “containing” are to be construed as open-ended terms (i.e., meaning “including, but not limited to,”) unless otherwise noted. The term “connected,” when unmodified and referring to physical connections, is to be construed as partly or wholly contained within, attached to or joined together, even if there is something intervening. Recitation of ranges of values in the present disclosure are merely intended to serve as a shorthand method of referring individually to each separate value falling within the range unless otherwise indicated, and each separate value is incorporated into the specification as if it were individually recited. The use of the term “set” (e.g., “a set of items”) or “subset” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but the subset and the corresponding set may be equal. The use of the phrase “based on,” unless otherwise explicitly noted or clear from context, means “based at least in part on” and is not limited to “based solely on.”

Conjunctive language, such as phrases of the form “at least one of A, B, and C,” or “at least one of A, B and C,” unless specifically noted otherwise or otherwise clearly contradicted by context, is otherwise understood with the context as used in general to present that an item, term, etc., could be either A or B or C, or any nonempty subset of the set of A and B and C. For instance, in the illustrative example of a set having three members, the conjunctive phrases “at least one of A, B, and C” and “at least one of A, B, and C” refer to any of the following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present.

Operations of processes described can be performed in any suitable order unless otherwise indicated or otherwise clearly contradicted by context. Processes described (or variations and/or combinations thereof) can be performed under the control of one or more computer systems configured with executable instructions and can be implemented as code (e.g., executable instructions, one or more computer programs or one or more applications) executing collectively on one or more processors, by hardware or combinations thereof. In some embodiments, the code can be stored on a computer-readable storage medium, for example, in the form of a computer program comprising a plurality of instructions executable by one or more processors. In some embodiments, the computer-readable storage medium is non-transitory.

The use of any and all examples, or exemplary language (e.g., “such as”) provided, is intended merely to better illuminate embodiments of the invention and does not pose a limitation on the scope of the invention unless otherwise claimed. No language in the specification should be construed as indicating any non-claimed element as essential to the implementation of the invention.

Embodiments of this disclosure are described, including the best mode known to the inventors for carrying out the invention. Variations of those embodiments will become apparent to those of ordinary skill in the art upon reading the description below. The inventors expect skilled artisans to employ such variations as appropriate and the inventors intend for embodiments of the present disclosure to be implemented otherwise than as specifically described. Accordingly, the scope of the present disclosure includes all modifications and equivalents of the subject matter recited in the claims appended hereto as permitted by applicable law. Moreover, any combination of the above-described elements in all possible variations thereof is encompassed by the scope of the present disclosure unless otherwise indicated or otherwise clearly contradicted by context.

All references, including publications, patent applications, and patents, cited are hereby incorporated by reference to the same extent as if each reference were individually and specifically indicated to be incorporated by reference and were set forth in its entirety.

1. A computer-implemented method, comprising:
providing, to a monitoring service, a filter rule that corresponds to a first set of user records at a service provider, wherein the monitoring service comprises a service, separate from the service provider, that monitors interactive multiuser computer services;
receiving a first notification from the monitoring service indicating that a match to the filter rule has been detected in a first message on a platform of an interactive multiuser computer service, the match including a value, the first message generated by a user of the platform;
as a result of determining, based at least in part on the first notification from the monitoring service, that the user is associated with a second set of user records at the service provider, causing, by transmitting a second notification to a client device of the user, an application on the client device to generate an interface with a prompt to authorize a transfer according to the value;
in response to receiving, from the client device, an authorization of the transfer, completing the transfer; and
transmitting, to the interactive multiuser computer service, a third message indicating successful completion of the transfer.

2. The computer-implemented method of claim 1, wherein completing the transfer includes:
deducting the value from an amount stored in the second set of user records; and
adding the value to an amount stored in the first set of user records.

3. The computer-implemented method of claim 1, wherein:
the computer-implemented method further comprises registering an association between the second set of user records at the service provider and a third set of user records at the interactive multiuser computer service; and
determining that the user is associated with the second set of user records includes determining, based at least in part on the association, that the first message on the platform is associated with the third set of user records.

4. The computer-implemented method of claim 1, wherein:
the computer-implemented method further comprises registering an association between the filter rule and an entity; and
completing the transfer includes determining, based at least in part on the association, that the entity is an intended recipient of the transfer.

5. A system, comprising:
one or more processors; and
memory including computer-executable instructions that, if executed by the one or more processors, cause the one or more processors of the system to:
obtain, at a monitoring service, a filter rule that corresponds to an entity, wherein the monitoring service comprises a service, separate from a service provider, that monitors interactive multiuser computer services;
determine, at the monitoring service, an occurrence of a match to the filter rule in a first message on a platform of an interactive multiuser computer service;
cause an application on a device of a user associated with the first message to prompt the user to authorize a transfer according to a value included in the first message;
receive, via the device of the user, an indication from the user; and
if the indication is authorization to complete the transfer:
complete the transfer between a set of user records of the user at a provider and the entity, the provider being a separate entity from the entity; and
transmit, to the interactive multiuser computer service, a second message indicating completion of the transfer.

6. The system of claim 5, wherein the computer-executable instructions further include instructions that cause the system to, if the indication denies authorization to complete the transfer:
cancel the transfer; and
transmit, to the interactive multiuser computer service a third message indicating that the transfer was not completed.

7. The system of claim 5, wherein the computer-executable instructions further include instructions that cause the system to determine the match based at least in part on a notification from the monitoring service that the match was found in the first message.

8. The system of claim 5, wherein the filter rule corresponds to a metadata tag included within the first message.

9. The system of claim 5, wherein the computer-executable instructions further include instructions that cause the system to:
receive a request from the entity to register the filter rule with the provider; and
register the filter rule in association with the provider.

10. The system of claim 5, wherein the second message is transmitted as a comment replying to the first message.

11. The system of claim 5, wherein the computer-executable instructions that cause the system to cause the application to prompt the user to authorize the transfer further cause the application to authenticate the user with the provider.

12. The system of claim 5, wherein:
the value in the first message lacks a numerical value for a transfer amount; and
the computer-executable instructions that cause the system to cause the application to prompt the user further include instructions that cause the system to cause the application to prompt the user for the transfer amount.

13. A non-transitory computer-readable storage medium having stored thereon executable instructions that, if executed by one or more processors of a computer system, cause the one or more processors of the computer system to at least:
provide, to a monitoring service, a filter rule that corresponds to an entity set of user records at a provider service, wherein the monitoring service comprises a service, separate from the provider service, that monitors interactive multiuser computer services;
receive a first notification from the monitoring service indicating a match to the filter rule in a first message on a platform of an interactive multiuser computer service;
determine whether the first message is associated with a user with a user set of user records at the provider service;
cause an application on a user device of the user to prompt the user to authorize a transfer according to a value included in the first message;
in response to receipt, from the user device, of an authorization of the transfer, complete the transfer; and
transmit, to the interactive multiuser computer service, a second message indicating completion of the transfer.

14. The non-transitory computer-readable storage medium of claim 13, wherein the executable instructions that cause the computer system to cause the user device to prompt the user include instructions that cause the computer system to cause, at least in part as a result of sending an authorization notification to the user device, the user device to execute an application on the user device to prompt the user to authorize the transfer.

15. The non-transitory computer-readable storage medium of claim 13, wherein:
the executable instructions further include instructions that cause the computer system to store, in response to receipt of a registration request from an entity corresponding to the entity set of user records, a metadata tag in association with the entity; and
the filter rule is based at least in part on the metadata tag.

16. The non-transitory computer-readable storage medium of claim 13, wherein:
the first notification includes information usable to identify the user set of user records associated with the first message; and
the executable instructions that cause the computer system to determine that the first message is associated with the user include instructions that cause the computer system to determine that the information corresponds to another set of user records the user has with the provider service.

17. The non-transitory computer-readable storage medium of claim 13, wherein the executable instructions that cause the computer system to determine that the first message is associated with the user with the user set of user records include instructions that cause the computer system to:
determine that the user associated with the first message does not yet have a set of user records with the provider service;
transmit, to the user, a third message via the interactive multiuser computer service to prompt the user to download the application; and
as a result of receiving registration information from the user device indicating that the user has downloaded and installed the application on the user device, create the user set of user records for the user.

18. The non-transitory computer-readable storage medium of claim 13, wherein the executable instructions that cause the computer system to cause the application on the user device to prompt the user include instructions that cause the computer system to cause the application on the user device to prompt the user by sending a second notification to the user device.

19. The non-transitory computer-readable storage medium of claim 13, wherein the filter rule corresponds to a hashtag registered with the provider service in association with the entity set of user records.

20. The non-transitory computer-readable storage medium of claim 19, wherein the filter rule further corresponds to a unit type and numeric value, wherein the unit type and numeric value are separate from the hashtag.
